(19) United States
(12) Patent Application Publication
(10) Pub. No.: US 2003/0146692 A1
(43) Pub. Date: Aug. 7, 2003

(54) Organic EL device and manufacturing method therefor, electrooptic apparatus, and electronic apparatus

(75) Inventor: Masahiro Uchida, Chino-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/330,357

(22) Filed: Dec. 30, 2002

(30) Foreign Application Priority Data
Jan. 11, 2002 (JP) 2002-004938
Jan. 11, 2002 (JP) 2002-004939

(51) Int. Cl. H05B 33/00

(52) U.S. Cl. 313/504

(57) ABSTRACT

Manufacturing method comprises steps of forming a functional layer on an electrode which is formed on a base board, forming a facing electrode which faces the electrode so as to sandwich the functional layer by performing vacuum deposition operation. The base board converting step for converting the base board is arranged between the functional layer forming step and the facing electrode forming step.

By doing this, it is possible to provide a manufacturing method for an organic EL device and a device therefor in which various member for forming the functional layer can be used and it is easy to optimize the structure of the organic EL device.

### BACKGROUND OF THE INVENTION

1. Field of the Invention

Present invention relates to manufacturing method for an organic EL device and a manufacturing device therefor, an electrooptic apparatus, and an electronic apparatus.

2. Description of Related Art

An electrooptic apparatus (organic EL display device) having an illuminating element such as an organic electroluminescent element (hereinafter called as an organic El device) is superior in displaying in that the organic EL display device illuminates brightly by itself under direct-current-low-voltage condition with high speed response by a solid organic layer. Such an organic EL display device is thought to be a next-generation display device because it is possible the organic EL display device is manufactured with thin depth and light weight and large display size while consuming less electricity.

FIG. 28 is a cross section showing an important part of such an organic EL display device.

An organic EL display device is formed by layering a circuit element section 901, a pixel electrode (anode) 902, an organic functional layer 903 including an illuminating layer, facing electrode (cathode) 904, and a sealing section 905 and the like in such an order. An illuminating element (organic EL device) is formed by the pixel electrode 902, the functional layer 903, and the facing electrode 904.

The functional layer 903 which is disposed between the pixel electrode 902 and the facing electrode 904 illuminates by a drive-control by the circuit element section 901 in this display device. The illuminating light transmits through the circuit element section 901 and the base board 900 so as to be ejected. A light which is emitted from the functional layer 903 away from the base board 900 is reflected by the facing electrode 904. The reflected light transmits through the circuit element section 901 and the base board 900 so as to be emitted therefrom.

For manufacturing the above organic EL device and a device for manufacturing therefor, vacuum deposition method is employed for forming the above functional layer in which vacuum deposition of a member for forming the functional layer is performed in a preferred area (pixel area) over a mask having a predetermined pattern. Such vacuum deposition method is commonly employed so as to form a facing electrode (cathode).

In a manufacturing method for a conventional organic EL device, various processing are performed under condition that surfaces to be processed are disposed downwardly.

Various members for forming an organic EL device particularly such as a functional layer are used according to new technology for seeking more efficient illumination, longer fatigue life, stability, and durability. It is strongly requested that manufacturing method for an organic EL device for such purposes and a manufacturing device therefor are invented.

### SUMMARY OF THE INVENTION

The present invention was made in consideration of the above problems. An object of the present invention is to provide an organic EL device and manufacturing method therefor in which various member can be used flexibly and it is easy to optimize a structure of the organic EL device.

Other object of the present invention is to provide an electrooptic apparatus which is provided with an organic EL device having superior quality.

Other object of the present invention is to provide an electronic apparatus having superior display quality.

According to the present invention, it may be preferable that the manufacturing method for an organic EL device according to the present invention comprises steps of forming a functional layer on an electrode which is formed on a base board, forming a facing electrode which faces the electrode so as to sandwich the functional layer by performing vacuum deposition operation, wherein base board converting step for converting the base board is arranged between the functional layer forming step and the facing electrode forming step.

According to the above manufacturing method for an organic EL device, the base board converting step for converting the base board is arranged between the functional layer forming step and the facing electrode forming step. The surface of the base board is disposed upwardly so as to be processed in the functional layer forming step. The surface of the base board is disposed downwardly so as to be processed in the facing electrode forming step in which vacuum deposition operation is performed. The surface of the base board is disposed downwardly in the functional layer forming step; thus, it is possible to use various member such as a less viscous member as a forming member for the functional layer. Also, it is possible to employ a gravity such as a self-flattening function (self-leveling function) for forming the functional layer.

More specifically, it is preferable that a liquid drop which includes a member for forming the functional layer on the base board is ejected in the functional layer forming step. By ejecting the liquid drop, it is possible to use various member for forming the functional layer.

Also, it maybe preferable that the base board is transported from a device for forming the functional layer after the functional layer is formed and the base board is converted in the manufacturing method for the above organic EL device. Also, it may be preferable that the base board is transported to a position where the facing electrode is formed by performing vacuum deposition operation and the base board is converted.

By converting the base board while transporting the base board between the devices, it is possible to restrict the reduction of the product yield due to the converting operation.

It may be preferable that the manufacturing device for an organic EL device according to the present invention comprises a functional layer forming device for forming a functional layer on en electrode which is formed on a base board, a base board converting device for converting the base board on which the functional layer is formed, and a facing electrode forming device for forming a facing electrode which faces the electrode so as to sandwich the functional layer by performing vacuum deposition operation.

The above manufacturing device for an organic EL device is provided with the above base board converting device; thus, processes in the functional layer forming device is performed such that the a surface of base board to be processed is disposed upward. The surface of the base board is disposed downwardly; thus, it is possible to use various member such as a less viscous member as a forming member for the functional layer. Also, it is possible to employ a gravity such as a self-flattening function (self-leveling function) for forming the functional layer.

More specifically, in the manufacturing device for an organic EL device according to the present invention, it is preferable that the functional layer forming device is provided with a liquid drop ejecting device for ejecting a member which forms the functional layer on the base board.

By doing this, it is possible to eject the above functional layer forming member to the base board; thus, it is possible to form the functional layer.

By using the liquid drop ejection method for forming the functional layer, it is possible to use various member for forming the functional layer.

Similarly to a case in which the functional layer forming device is a spin coating device, it is possible to use various member such as less viscous member for forming the functional layer.

In a manufacturing device for an organic EL device according to the present invention, it is preferable that the base board converting device transports the base board to and from a position where the facing electrode is formed by performing vacuum deposition operation.

The base board converting device transports the base board; therefore, processes before and after the facing electrode forming device are performed while a surface of the base board to be processed is disposed upwardly. Also, it is possible to convert the base board along with the transportation operation; thus, it is possible to restrict the reduction in the product yield due to the converting operation.

Also, in the manufacturing device for an organic EL device according to the present invention, the base board converting device is disposed between the functional layer forming device and the facing electrode forming device. By doing this, it is possible to convert the base board simultaneously with the transportation of the base board between the functional layer forming device and the facing electrode forming device. Therefore, it is possible to restrict the reduction in the product yield due to the converting operation.

It may be preferable that the electrooptic apparatus according to the present invention is provided with an organic EL device which is manufactured by a manufacturing device for the organic EL device according to the present invention.

According to the above electrooptic apparatus, the organic EL device is manufactured by using the above manufacturing device; therefore, the structure in the organic EL device is optimized; thus, the quality of the organic EL device can be improved.

It may be preferable that the electronic device according to the present invention is provided with an electrooptic apparatus as a display device.

By using the above electrooptic apparatus, quality of the display device can be improved.

Also, it may be preferable that the manufacturing method for an organic EL device according to the present invention comprises steps of forming a cathode for the organic EL device which is formed on the base board by performing vacuum deposition operation, and sealing the organic EL device. It may be also preferable that the base board is converted after the cathode forming step before the sealing step.

According to the manufacturing method for the above organic EL device, the base board is upset vertically between the above cathode forming step and the sealing step; therefore, the surface of the base board to be processed is disposed downwardly in the cathode forming step in which the vapor disposition operation is performed. Also, the surface of the base board to be processed is disposed upwardly in the sealing step. The surface of the base board to be processed is disposed upwardly in the sealing step; therefore, it is possible to use various member such as a less viscous member as a forming member for the functional layer. Also, it is possible to employ a gravity such as a self-flattening function (self-leveling function) for forming the functional layer.

More specifically, it may be preferable that, in the manufacturing method for an organic EL device according to the present invention, the sealing step includes a step for applying a sealing member on the cathode. In such a case, it is possible to apply the sealing member easily by using the gravity.

Also, it may be preferable that, in the manufacturing method for an organic EL device according to the present invention, the base board is converted to a position where the cathode is formed by performing vacuum deposition operation according to the transportation of the base board.

By converting the base board while the base board is transported to the space for the vapor deposition, it is possible to restrict the reduction in the product yield due to the converting operation.

The manufacturing device for an organic EL device according to the present invention may comprise a cathode forming device for forming a cathode for the organic EL device which is formed on the base board by performing vacuum deposition operation, a base board converting device form converting the base board, and a sealing device for sealing the organic EL device. The above manufacturing device for the organic EL device is provided with the above base board converting device; therefore, the surface of the base board to be processed is disposed upwardly in the sealing device.

By disposing the surface to be processed of the base board upwardly, it is possible to use various member such as a less viscous member as a forming member for the functional layer. Also, it is possible to employ a gravity such as a self-flattening function (self-leveling function) for forming the functional layer.

More specifically, it may be preferable that, in the manufacturing device for an organic EL device according to the present invention, the sealing device is provided with a sealing member applying section for applying the sealing member on the cathode. In such a case, it is possible to apply the sealing member easily by using the gravity.

Also, it maybe preferable that, in the manufacturing device for an organic EL device according to the present invention, the base board converting device transports the base board to a position where the cathode is formed by performing vacuum deposition operation.

The base board converting device is formed in the base board transporting device; therefore, it is possible to convert the base board simultaneously with the transportation of the base board. Thus, it is possible to restrict the reduction in the product yield due to the converting operation.

The electrooptic apparatus according to the present invention is provided with an organic EL device which is manufactured by a manufacturing device for an organic EL device according to the present invention; thus, it is possible to optimize the structure of the organic EL device and improve its quality.

It may be preferable that the electronic apparatus according to the present invention is provided with an electrooptic apparatus according to the present invention.

According to the above electrooptic apparatus, it is possible to improve the quality of the display section.

In the manufacturing device for an organic EL device and the method therefor according to the present invention, the base board is upset vertically between the functional layer forming step and the facing electrode forming step. Thus, it is possible to use various member for forming the functional layer. Therefore, various member can be used flexibly; thus, it is possible to optimize the structure of the organic EL device easily.

Also, in the manufacturing device for an organic EL device and the method therefor according to the present invention, the base board is upset vertically between the cathode forming step and the sealing step. Thus, it is possible to use various member as a sealing member. Therefore, various function ca be added to the sealing section; thus, it is possible to improve the quality of the organic EL device.

According to the electrooptic device according to the present invention, it is possible to optimize the structure of the organic EL device and improve the quality thereof.

Furthermore, the electrooptic apparatus according to the present invention is provided with the above electrooptic device as a display section; thus, it is possible to improve the quality of the display section.

### BRIEF DESCRIPTION OF THE DRAWINGS

FIG. 1 is a view for explaining a general concept for a manufacturing method for an organic EL device according to the present invention.

FIG. 2 is a view for explaining a liquid drop ejecting theory according to a piezoelectric method.

FIG. 3 shows an embodiment of the manufacturing device for the organic EL device according to the present invention graphically.

FIG. 4 is a view showing a general structure of a functional layer forming device.

FIGS. 5A and 5B are general views showing an example of an transportation system which includes a distributing device and a handling device. FIG. 5A is a plan view. FIG. 5B is a side view.

FIG. 6 is a view showing a facing electrode (cathode) forming device and a sealing device graphically.

FIGS. 7A to 7C are showing examples of the transportation system in the facing electrode forming device.

FIG. 8 is a view showing an example for a vapor deposition chamber graphically.

FIG. 9 is a view showing a structure of an organic EL device as an embodiment of the electrooptic device according to the present invention.

FIG. 10 is an example for a circuit diagram of an active matrix organic EL device.

FIG. 11 is an enlarged cross section of a display section in the organic EL device.

FIG. 12 shows an internal structure in a first plasma processing chamber in a plasma processing device.

FIG. 13 is a view explaining a manufacturing method for an organic EL device.

FIG. 14 is a view explaining a manufacturing method for an organic EL device.

FIG. 15 is a view explaining a manufacturing method for an organic EL device.

FIG. 16 is a plan view showing a head of a liquid drop ejecting device (ink jet head).

FIG. 17 is a plan view showing a liquid drop ejecting device (ink jet device).

FIG. 18 is a view explaining a manufacturing method for an organic EL device.

FIG. 19 is a view explaining a manufacturing method for an organic EL device.

FIG. 20 is a view explaining a manufacturing method for an organic EL device.

FIG. 21 is a view explaining a manufacturing method for an organic EL device.

FIG. 22 is a view explaining a manufacturing method for an organic EL device.

FIG. 23 is a view explaining a manufacturing method for an organic EL device.

FIG. 24 is a view showing an example of a structure of a sealing section graphically.

FIG. 25 is a view showing an example of a structure of a sealing section graphically.

FIG. 26 is a view showing an example of a structure of a sealing section graphically.

FIGS. 27A to 27C show embodiments of electronic apparatus according to the present invention.

FIG. 28 is a cross section of an organic EL display device which is provided with an organic EL device as an example for an electrooptic element graphically.

FIG. 29 is a view for explaining a general concept for a manufacturing method for an organic EL device according to the present invention.

FIG. 30 is a view showing an example of a structure of a sealing section graphically.

FIG. 31 is a view showing an example of a structure of a sealing section graphically.

FIG. 32 is a view showing an example of a structure of a sealing section graphically.

### DETAILED DESCRIPTION OF THE INVENTION

The present invention is explained in detail as follows.

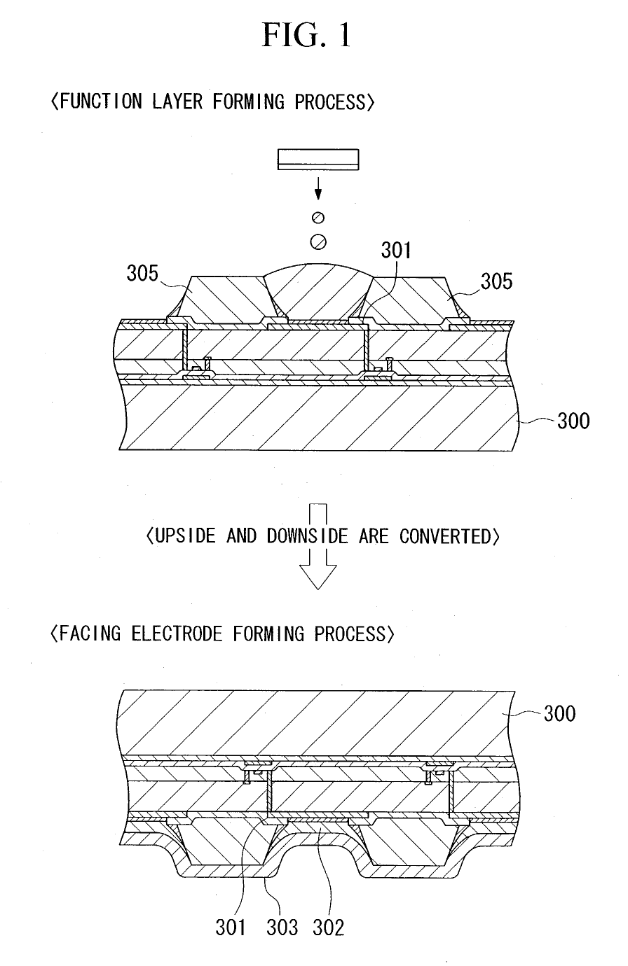

FIG. 1 is a view for explaining a general concept for a manufacturing method for an organic EL device according to the present invention.

An organic EL device is manufactured by stacking an electrode 301 (anode), a functional layer 302 containing an illuminating layer (organic EL layer), and a facing electrode 303 (cathode) on a base board 300 on which a circuit element such as a thin-film-transistor (hereinafter called a TFT) are formed.

An inventor of the present invention found that more various members for forming the functional layer 302 are being used; thus, a surface of the base board 300 to be processed is disposed upwardly in the functional layer forming step for forming a functional layer 302 and a surface of the base board 300 to be processed is disposed downwardly in the facing electrode forming step for forming the facing electrode 303 by upsetting the base board 300 vertically between the functional layer forming step for forming the functional layer 302 and the facing electrode forming step for forming the facing electrode 303.

That is, in the manufacturing method according to the present invention, a surface of the base board 300 to be processed is disposed upwardly in the functional layer forming step for forming the functional layer 302 and a surface of the base board 300 to be processed is disposed downwardly in the facing electrode forming step for forming the facing electrode 303 by upsetting the base board 300. By disposing the surface of the base board 300 to be processed upwardly in the functional layer forming step for forming the functional layer 302, it is possible to use various member such as a less viscous member as a forming member for the functional layer 302. Also, it is possible to employ a gravity such as a self-flattening function (self-leveling function) for forming the functional layer 302. Here, vapor disposition method is employed in a facing electrode forming step for forming the facing electrode 303.

Here, in this specification, the member for forming the functional layer may be simplified as “the member”.

For a forming method for forming the functional layer 302 while the base board 300 is disposed upwardly, various methods can be employed such as s spin-coat method, a liquid drop ejecting method (so called an ink jet method), and a dispense-coat method. According to these coating method, a member for forming the functional layer is dispersed in a soluble; thus, it is possible to use various member for forming the functional layer. Among the above coating methods, the liquid drop ejecting method has an advantage in that the member for forming the functional layer can be used efficiently and a preferable amount of the member can be disposed in a preferable position accurately. In addition, when the functional layer 302 is formed by using a less viscous member, it is preferable that a bank 305 is disposed such that a plurality of neighboring members for forming the functional layers not be mixed each other. However, the present invention is not limited only in such structure.

For a liquid drop ejecting method (inkjet method), a charging control method, a vibration method, an electromechanic converting method, an electrothermo converting method, and an electrostatic absorbing method can be named. According to the charging control method, an electric charge is applied to a member from a charging electrode so as to control a flying direction of the member by a deflecting electrode; thus the member is ejected from a nozzle. Also, according to the vibration method, an extra-high tension is applied to the member so as to eject the member from the tip of the nozzle. When a control voltage is not applied to the member, the member progresses linearly; thus, the member is ejected from the nozzle. When a control voltage is applied to the members, the members repulses each other; thus, the members disperse and the member is not ejected from the nozzle. The electromechanic converting method (piezoelectric method) make use of a phenomena in that the piezoelectric element (piezoelectric element) is deformed by a pulse electric signal. According to the electromechanical converting method, pressure is applied to a space which stores the member via a flexible member by deforming the piezoelectric element; thus, the member is ejected from the space so as to be ejected from the nozzle. Also, according to the electro-thermo converting method, the member is rapidly evaporated by a heater which is disposed in a space which stores the member so as to generate bubbles; thus, the member in the space is ejected by the pressure in the bubble. According to the electrostatic absorbing method, a small amount of pressure is applied to the space which stores the member so as to form a meniscus made from the member in the nozzle. In the electrostatic absorbing method, the member is drawn by applying an electrostatic gravity under such a condition. Other than these methods, it is possible to use a method which makes use of transition of viscosity of a liquid member due to an electric field and a method in which the member is ejected by using a discharging spark.

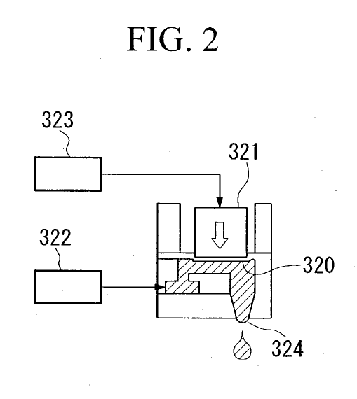

FIG. 2 is a view for explaining a liquid drop ejecting theory according to a piezoelectric method. As shown in FIG. 2, a piezoelectric element 321 is disposed so as to be neiboring a liquid member chamber 320 which stores the liquid member. The liquid member is supplied to the liquid member chamber 320 via a liquid member supply system 322 which contains a member tank for containing the liquid member. The piezoelectric element 321 is connected to a driving circuit 323. Electric voltage is charged to the piezoelectric element 321 via the driving circuit 323 so as to deform the piezoelectric element 321. By doing this, the liquid member chamber 320 deforms and the liquid member is ejected from the nozzle 324. In such a case, a distortion of the piezoelectric element 321 is controlled by changing the applied voltage. Also, a distortion speed of the piezoelectric element 321 is controlled by changing a frequency of the applied voltage.

When the liquid drop is ejected according to the piezoelectric method, a heat is not applied to the member; therefore, there is an advantage in that the composition of the member is hardly affected.

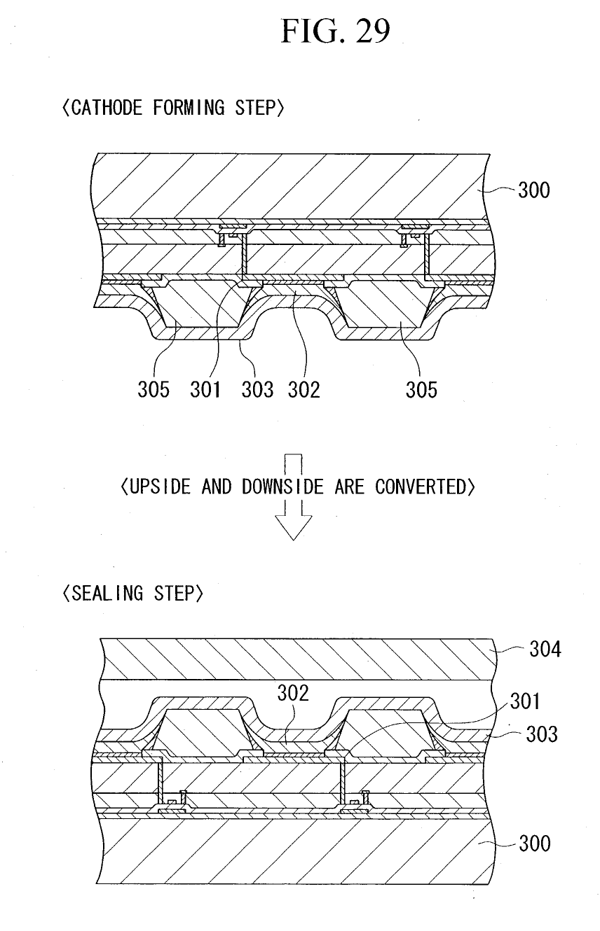

According to a method which is explained by FIG. 29, an organic EL device is manufactured by stacking an electrode 301 (anode), a functional layer 302 which contains an illuminating layer (organic EL layer), and a facing electrode 303 (cathode) successively on a base board 300 on which a circuit element such as a TFT is formed. The organic EL device is sealed by a sealing section 304 which is disposed on the cathode 303.

The inventor of the present invention found that more functions are required for the sealing section 304; thus, the surface of the base board 300 is disposed downwardly in the step for forming the cathode 303 and the surface of the base board 300 is disposed upwardly in a sealing step by upsetting the base board 300 between the step for forming the cathode 303 and the sealing step.

That is, according to the manufacturing method according to the present invention, the surface of the base board 300 is disposed downwardly so as to be processed in the step for forming the cathode 303 and the surface of the base board 300 is disposed upwardly so as to be processed in a sealing step by upsetting the base board 300. In the sealing step, the surface of the base board 300 to be processed is disposed upwardly; thus, various member such as a less viscous member can be used for a member for forming a sealing section 304. Also, it is possible to employ a gravity such as a self-flattening function (self-leveling function) for disposing a member for forming the sealing section 304. Here, a vapor deposition method is employed for a step for forming the cathode 303.

For a method in which a sealing section 304 is formed while the base board 300 is disposed upwardly, various methods such as a spin-coat method, a liquid drop ejecting method (so called an ink jet method), and a dispense-coat method can be named. According to these coating methods, various member for a sealing member can be used by dispersing the member in a soluble. Also, among these coating methods, the liquid drop ejecting method is advantageous in that the member can be used efficiently and it is possible to dispose a preferable amount of the member to a preferable position accurately.

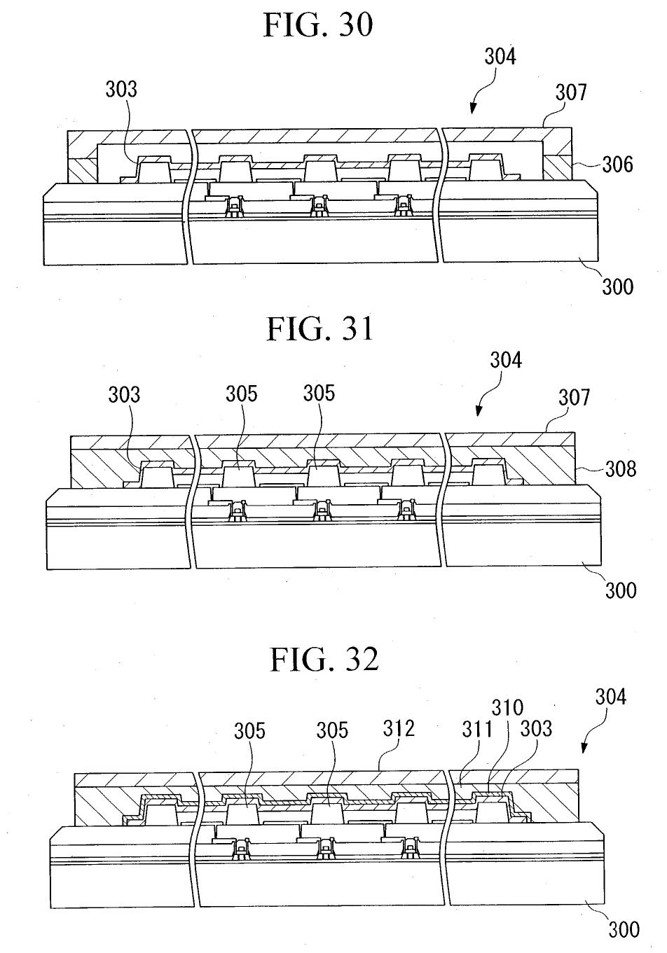

FIGS. 30, 31, and 32 show examples of structure of a sealing section 304 graphically. In an embodiment shown in FIG. 30, a sealing resin 306 is disposed around a marginal region of the base board 300 and a sealing base board (sealing can) 307 which is made of a glass member or a metal member such that the sealing base board 307 covers the cathode 303 is disposed by a bonding agent such as a sealing resin 306.

In the sealing step, the base board on which the cathode 303 is formed is supported upwardly on a predetermined surface and the sealing resin 306 is applied around a marginal region of the base board 300. Consequently, the sealing base board 307 is disposed on the base board 300. After that, the base board 300 and the sealing base board 307 are attached together. In this embodiment, a surface which supports the base board 300 is disposed beneath the base board 300; therefore, there is an advantage in that it is possible to simplify the structure of a device which is used for the sealing step.

In an embodiment shown in FIG. 31, a sealing member 308 is applied so as to cover approximately entire cathode 12. A sealing base board (sealing can) 309 is disposed on the sealing member 308. For a sealing member 308, for example, a thermosetting resin or an ultra-violet ray curable resin which do not generate a gas or soluble when those resins are hardened are preferably used. Such a sealing member has a function for preventing a water or an oxygen from invading into the cathode 303 and avoiding oxidization of the cathode.

In the sealing step, the sealing member 308 is applied so as to cover the entire cathode 303 on the base board 300 which is disposed upwardly. The sealing base board 309 is disposed further thereon. In such a case, a surface of the sealing member 308 is flattened by a self-leveling function due to the gravity. That is, as shown in the present embodiment, it is possible to flatten the surface of the element by applying the sealing member 308 by using the leveling function even if the bank 305 is formed on the base board 300. Here, there is an advantage in that it is possible to restrict the distortion in a light which transmits or is reflected there by flattening a surface of the layer.

In an embodiment shown in FIG. 32, a first sealing member 310 is disposed so as to cover approximately entire cathode 12. A second sealing member 311 is disposed on the first sealing member 310. A sealing base board 312 is disposed on the second sealing member 312. The first sealing member 310 has a specific function such as a function for reinforcing the sealing effect for preventing a water, an oxygen, or a metal member from invading and an optical function for improving the extraction of a light (improving refractive index).

In the sealing step, a first sealing member 310 is applied so as to cover the entire cathode 303 on the base board 300 which is disposed upwardly. A second sealing member 311 is disposed thereon. A sealing base board 312 is disposed thereon finally. When the first sealing member 310 is applied, for example, a relatively thin layer is formed on the cathode 303. When the second sealing member 311 is applied, a relatively thick layer is formed such that gaps made by the bank 305 is filled. In the sealing step, the base board 300 is disposed upwardly; thus, it is possible to apply the sealing members so as to correspond to various thickness such as a thin layer or a thick layer. Therefore, it is possible to add a specific function to a sealing layer.

FIG. 3 shows an embodiment of the manufacturing device for the organic EL device according to the present invention graphically. Hereinafter, the manufacturing device is explained mainly with regard to the transporting system. Processes and steps in detail are explained later.

As shown in FIG. 3, a manufacturing device 20 for an organic EL device according to the present embodiment comprises a functional layer forming device 21, a facing electrode (cathode) forming device 22, and a sealing device 23.

The functional layer forming device 21 comprises a plasma processing device 25 for performing a preparatory process for forming a functional layer in the organic EL device, a positive hole implantation/transportation layer forming device 26 for forming a positive hole implantation/transportation layer as a part of the functional layer, an illuminating layer forming device 27 for forming an illuminating layer as a part of the functional layer. Also, a transporting systems which are included in a plurality of devices are disposed in approximately a continuous linear manner. Processing systems are disposed on both sides of the transporting system.

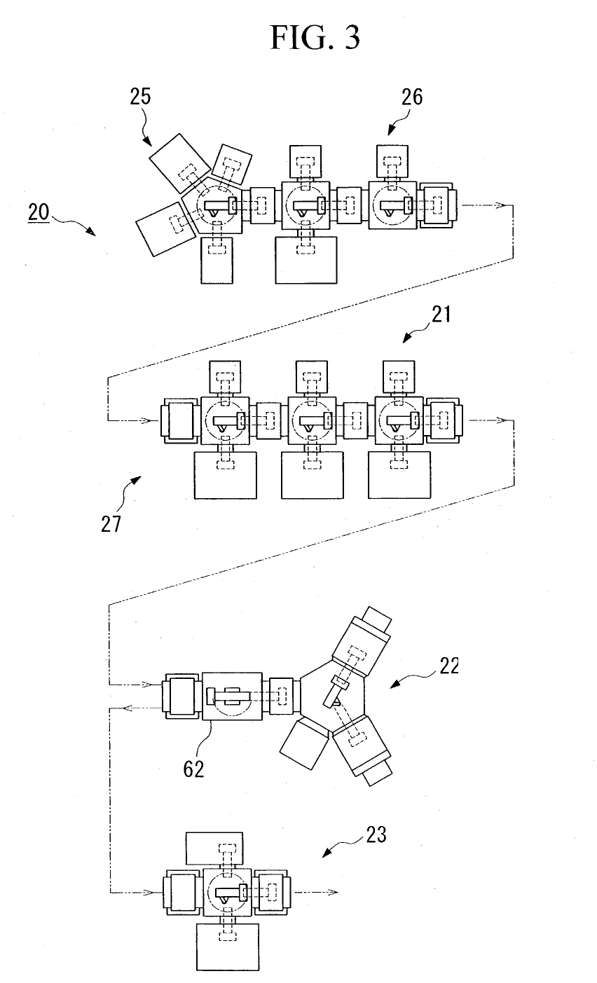

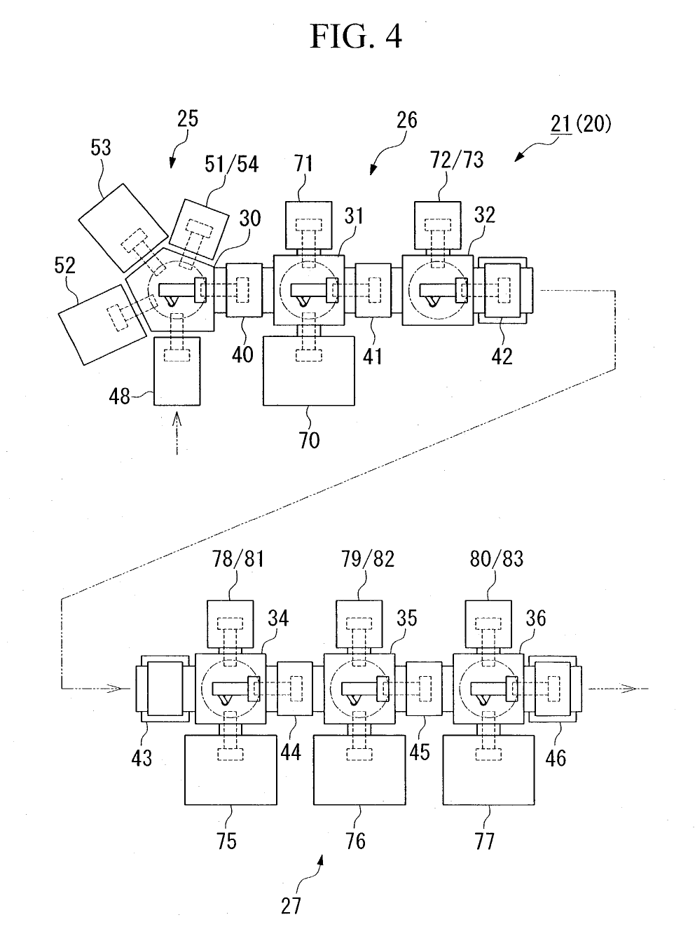

As shown in FIG. 4, in the transporting system, a plurality of distributing devices 30, 31, . . . , 36 which are provided with a handling arm having a multi-joint structure are disposed in a linear line manner so as to have intervals therebetween. A plurality of handling devices 40, 41, . . . , 46 for handling the base board are disposed between a plurality of the distributing devices 30, 31, . . . , 36. That is, a plurality of the distributing devices 30, 31, . . . , 36 and a plurality of the handling devices 40, 41, . . . , 46 are connected approximately in a staggered manner serially.

FIGS. 5A and 5B are general views showing an embodiment of an transportation system which includes a distributing device and a handling device. In FIGS. 5A and 5B, the distributing device is provided with a robot arm (transporting arm 37A) having a multi-joint structure which freely moves in a horizontal, vertical, and rotational direction around a vertical axis. A plurality of adhering holes 38 for holding the base board 2 are disposed in the transporting arm 37A. The adhering hole 38 is communicated to a vacuum pump which is not shown in the drawing so as to make use of pressure difference to hold the base body by the adhering effect.

Also, the handling device has a plurality of pins 47 for supporting the base body 2. Height of these pins 47 is determined such that a space is formed such that the transporting arm 37A can be inserted beneath the base board 2 when the base board 2 is mounted on a plurality of the pins 47.

When the base board 2 is handled, at first, a first transporting arm 37A moves to transport the base board 2 above a plurality of pins 47. After that, the transporting arm 37A descends so as to mount the base board 2 on a plurality of pins 47. The first transporting arm 37A moves away from a plurality of pins 47 after mounting the base board 2. Next, a second transporting arm 37B moves beneath the base board 2. After that, the second transporting arm 37B ascends so as to receive the base board 2 from a plurality of pins 47.

Here, the present invention is not limited to the above structure of the transporting system. In the above embodiment, the transporting arm moves vertically and the base board is transported and handled via a plurality of pins. However, it is acceptable that a structure for moving a plurality of pins vertically is disposed so as to transport and handle the base board by such a vertical movement of a plurality of pins. Furthermore, it is acceptable that a lining structure for lining a position of the base board. Also, the transporting system according to the present invention is provided with a transporting arm having a multi-joint structure; therefore, there is an advantage in that it is possible to handle the base boards to both sides of the transporting system. However, the present invention is not limited to such a structure. It is acceptable that other transporting section such as a roller conveyer can be employed in the present invention.

As shown in FIG. 4, the plasma processing device 25 is provided with a preparatory heating chamber 51, a first plasma processing chamber 52, a second plasma processing chamber 53, and a cooling processing chamber 54. The preparatory heating processing chambers 51 and the cooling processing chambers 54 are disposed in a common position in a multi-stage manner. Also, the preparatory heating processing chamber 51/the cooling processing chamber 54, the first plasma processing chamber 52, and the second plasma processing chamber 53 are disposed in a radial manner around the distributing device 30.

The base board to be processed is introduced therein via a base board introducing section 48. The base board is received by the distributing device 30. The distributing device 30 introduces the base board to the preparatory heating processing chamber 51, the first plasma processing chamber 52, the second plasma processing chamber 53, and the cooling processing chamber 54 successively. Simultaneously, the distributing device 30 transports the base board from each processing chamber after the base boards are processed. The base board which is processed in the plasma processing device 25 is sent to the positive hole implantation/transportation layer forming device 26 via the distributing device 30 and the handling device 40.

The positive hole implantation/transportation layer forming device 26 is provided with a application processing chamber 70 for applying a composition including a member for forming the positive hole implantation/transportation layer on the base board, a preparatory heating processing chamber 71, a heating processing chamber 72, and a cooling processing chamber 73. The heating processing chambers 72 and the cooling processing chambers 73 are disposed in a common position in multi-stage manner. Also, the application processing chamber 70 is disposed on either side (herein this embodiment, a right-hand side in the drawing) of the distributing devices 31 and 32 in a transportation direction of the base board. The preparatory heating processing chamber 71, the heating processing chamber 72/the cooling processing chamber 73 are disposed on the other side (herein this embodiment, a left-hand side in the drawing).

When the distributing device 31 receives a base boards from the handling device 40, the distributing device 31 introduces the base boards into the application processing chamber 70 and the preparatory heating processing chamber 71 successively. Simultaneously, the distributing device 31 transports the base boards after the base boards are processed so as to send them to the handling device 41. Also, when the distributing device 32 receives the base boards from the handling device 41, the distributing device 32 sends the base boards into the heating processing chamber 72/cooling processing chamber 73 so as to transports there outside after the base boards are processed. The base boards which are processed by the positive hole implantation/transportation layer forming device 26 are sent to the illuminating layer forming device 27 via the distributing device 32 and the handling devices 42, 43.

Here, the handling device 42 has a buffer section for retaining a plurality of base boards temporarily. The base board which is retained in the buffer section is extracted by the transporting device which is not shown in the drawing at a preferable timing so as to be received by the handling device 43. The handling device 43 also has a buffer section for retaining a plurality of base boards temporarily. The base boards which are retained in the buffer section are extracted by the distributing device 34 at a preferable timing. In the present embodiment, a base board is contained in a cassette in the handling device 42 and the cassette is transported to the handling device 43.

An illuminating layer forming device 27 is provided with application processing chambers 75, 76, and 77 for applying the composition containing a member for forming the illuminating layer on the base board so as to correspond to either color such as red (R), green (G), or blue (B). Also, the illuminating layer forming device 27 is provided with the heating processing chambers 78, 79, and 80 and cooling processing chambers 81, 82, and 83 so as to correspond to the application processing chambers 75, 76, and 77. The heating processing chambers and the cooling processing chambers are disposed in a multi-stage manner in a common position. Also, the application processing chambers 75, 76, and 77 are disposed in a right-hand side of the distributing device in the drawing toward the transportation direction of the base board. The heating processing chambers 78, 79, and 80/cooling processing chambers 81, 82, and 83 are disposed on a left-hand side in the drawing.

When the distributing device 34 receives the base board from the handling device 43, the distributing device 34 introduces the base board to the application processing chamber 75, the heating processing chamber 78/cooling processing chamber 81 successively. Also, the distributing device 34 extracts the base board which is processed and sends the base board to the handling device 44. Similarly, the distributing device 35 and the distributing device 36 introduce base board to the processing chambers and extracts the base board from processing chambers. The base board which is processed in the illuminating layer forming device 27 is sent to the facing electrode (cathode) forming device via the distributing device 36 and the handling device 46.

Here, the application processing chambers 70, 75, 76, and 77 are disposed unitarily in a right-hand side of the transporting system 21 toward the transporting direction of the base board in the above functional layer forming device 21 in the drawing. Also, the heating devices and the cooling processing devices 78 to 83 are disposed unitarily in a left-hand side in the drawing. By doing this, these devices are similar with respect to their function; thus, even if a heat or a vibration occur among a plurality of processing devices, there hardly occurs inconveniences due to such affection. In addition, the heating processing chambers 78, 79, and 80 having a heat source and the application processing chambers 70, 75, 76, and 77 are disposed on both side of the transporting system separately; therefore, the application processing chambers hardly be affected by the heat generated in the heating processing chambers. Therefore, there are advantages in that the viscosity of the member to be applied hardly changes due to the heat application structure hardly changes due to the heat; thus, it is possible to improve the product quality easily.

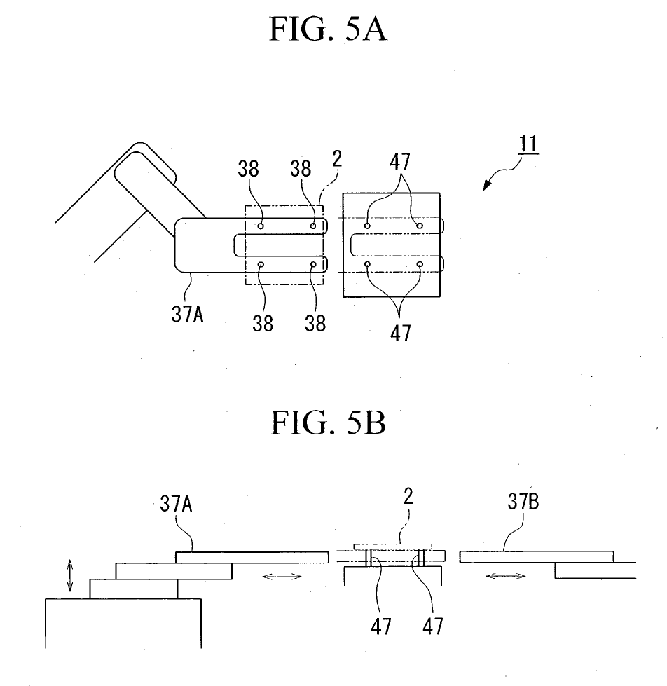

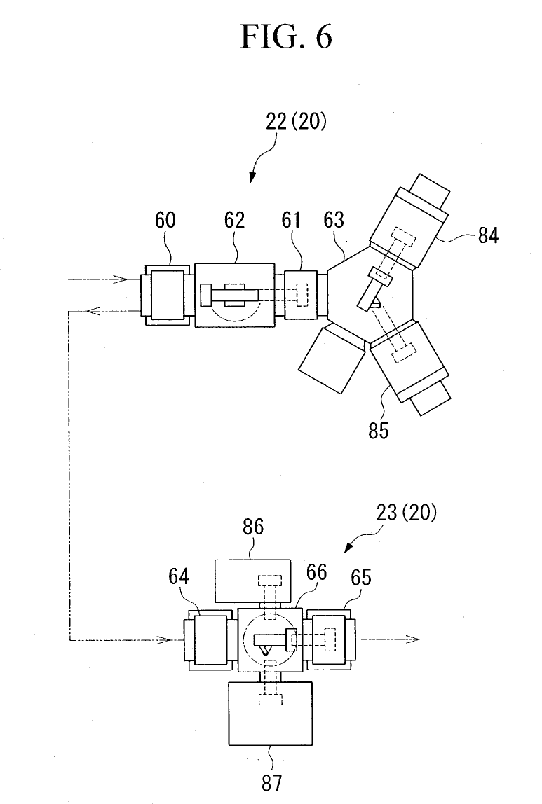

In FIG. 6, a facing electrode (cathode) forming device 22 and a sealing device 23 are shown.

In FIG. 6, the facing electrode (cathode) forming device 22 is provided with a first vapor deposition processing chamber 84, a second vapor deposition processing chamber 85, and a transporting system for transporting the base board. When the facing electrode is formed, at least either one of the first vapor deposition processing chamber 84 or the second vapor deposition processing chamber 85 is used selectively. The transporting system comprises a handling devices 60, 61, a base board converting device 62, and the distributing device 63.

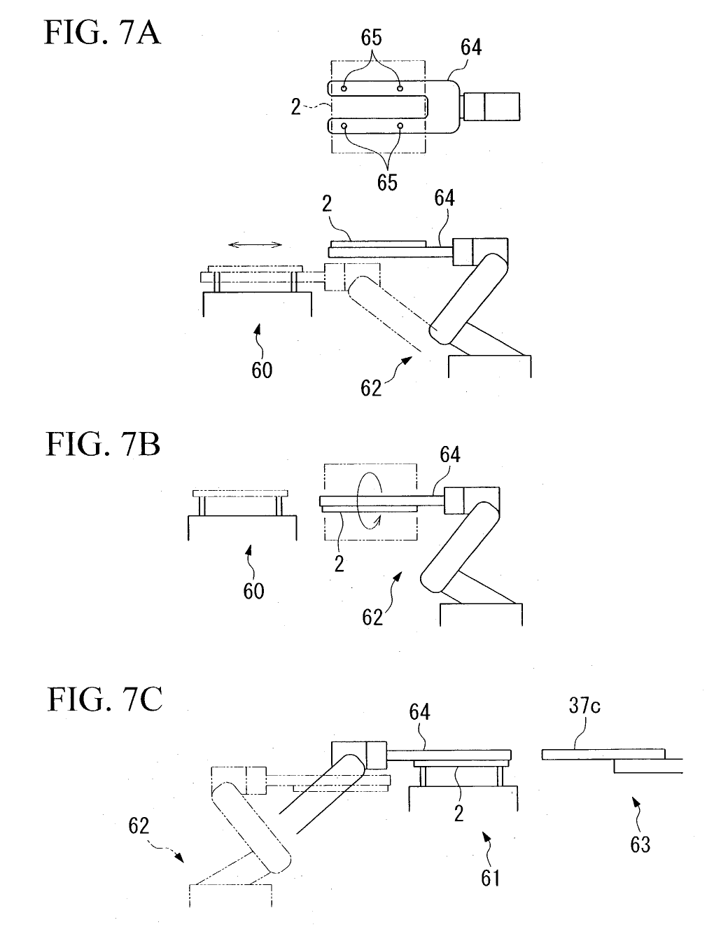

FIGS. 7A to 7C are showing examples of the transportation system in the facing electrode forming device 22 mainly with respect to the base board converting device 62.

In FIGS. 7A to 7C, the base board converting device 62 is provided with a robot arm (transporting arm 64) having a multi-joint structure which can move in a horizontal direction, a vertical direction, a rotational direction around the horizontal axis, and a rotational direction around the vertical axis. The transporting arm 64 is provided with a plurality of adhering holes 65 for retaining the base board 2. The adhering holes 65 are communicated to a vacuum pump which is not shown in the drawing so as to support the base board by an absorbing force which is obtained by a pressure difference.

When the base board is transported, at first, the base board 2 which is transported from the illuminating layer forming device is transported to the handling device 60 (FIG. 7A). When the base board converting device receives the base board 2 from the handling device 60, the base board converting device 62 upsets the base board 2 vertically and dispose the surface (element surface) of the base board 2 to be processed downwardly (FIG. 7B). When the base board 2 is converted, the base board 2 is absorbed by a vacuum force from the absorbing holes 65; thus, it is prevented that the base board 2 fall from the transporting arm 64. Next, the base board converting device 62 sends the vertically-converted base board 2 to the handling device 61 (FIG. 7C). When the distributing device 63 receives the base board 2 from the handling device 61, the distributing device 63 transports to either one of the first vapor deposition processing chamber 84 or the second vapor deposition processing chamber 85 shown in FIG. 6 while maintaining the vertically-converted condition.

Here, the base board converting device 62 is not limited to the above structure; thus, various forms of the base board converting device 62 can be used. Also, it is acceptable that a converting structure is provided to the distributing device 63 instead of using the base board converting device 62.

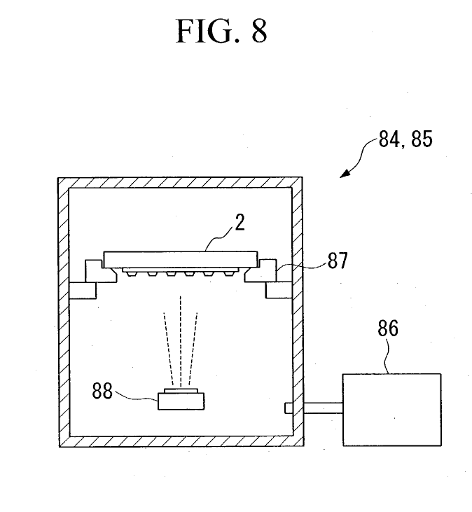

FIG. 8 is a view showing an example for a vapor deposition chambers 84 and 85 graphically.

The vapor deposition processing chambers 84 and 85 are provided with a vacuum controlling section 86 for controlling the in side of the vapor deposition processing chambers under a vacuum condition, a base board supporting section 87 for supporting the base board which is supposed to be processed for a vapor deposition, and a heating section 88 for heating the member. When the vapor deposition operation is performed, the inside of the vapor deposition processing chambers are maintained under a vacuum condition by the vacuum controlling section 86.

The base board supporting section 87 contains a member (mask) for supporting a marginal region of the base board 2. The member is provided with an opening mouth which corresponds to a pattern which is used in the vapor deposition operation. The base board 2 is disposed above the heating section 88 such that the surface of the base board 2 to be processed is disposed downwardly. The member is heated by the heating section 88 in the vapor deposition processing chamber inside of which is controlled to be under vacuum condition; thus, the evaporated member adheres the base board 2 and a facing electrode (cathode) is formed.

Back in FIG. 6, the distributing device 63 transports the base board to either one of the first vapor deposition processing chamber 84 or the second vapor deposition processing chamber 85 while maintaining the vertically-converted condition of the base board. Simultaneously, the distributing device 63 transports the processed base board from the vapor deposition processing chambers and sends the base board to the handling device 61.

After the vapor deposition processing operation is performed to the base board, the base board is sent to the handling device 61 under condition of the vertically-converted deposition. The base board converting device 62 transports the base board while upsetting the base board vertically according to an opposite manner to the above method in which the base board is transported into the processing chambers. That is, when the base board converting device 62 receives the base board from the handling device 61, the base board converting device 62 upsets the base board vertically so as to dispose a surface to be processed (element surface) of the base board upwardly. Consequently, the base board converting device 62 sends the base board 2 to the handling device 60. The base board which is sent to the handling device 60 is sent to the sealing device 23.

The sealing device 23 is provided with a sealing resin applicating processing device 86 for applying the bonding sealing resin, an attaching processing chamber 87 for attaching the base board and the sealing base board, and a transporting system for transporting the base board. The transporting system comprises the handling devices 64, 65 and the distributing device 66.

When the distributing device 66 receives the base board from the handling device 64, the distributing device 66 transports the base board to the sealing resin applying processing chamber 86 and the attaching processing chamber 87 successively. Also, the distributing device 66 transports the processed base board from the processing chambers so as to send the base board to the handling device 65.

By doing this, the manufacturing device 20 according to the present invention is provided with the base board converting device 62 which upsets the base board vertically between the functional layer forming device 21 and the facing electrode (cathode) forming device 22; thus, the base board is vertically upset by the base board converting device 62 while the base board is transported to and from the space where the vapor deposition is performed so as to form the facing electrode (cathode). By doing this, vapor deposition is performed while the surface to be processed of the base board is disposed upwardly in the functional layer forming device 21 (positive hole implantation/transportation layer forming device 26, the illuminating layer forming device 27). Thus, various members such as a less viscous member for forming the functional layer can be used. Also, when the functional layer is formed, it is possible to employ a gravity such as a self-flattening function (self-leveling function) for forming the functional layer. In particular, by employing the liquid drop ejecting method for forming the functional layer, it is possible to dispose various members in a preferable position accurately.

Also, the base board is processed while the surface to be processed is disposed upwardly in the sealing device 23; thus, there are above various advantages in that various members for forming the sealing member can be used.

Also, in the manufacturing device 20 according to the present invention, the base board is upset simultaneously with the transporting operation of the base board. Therefore, the manufacturing device 20 can be operated efficiently; thus, it is possible to restrict the reduction in the product yield due to the converting operation of the base board. In addition, the base board converting device 62 is provided in the facing electrode forming device 22; thus, a surface to be processed of the base board is disposed upwardly while the base board is processed before and after the step in the facing electrode forming device 22. A position where the base board converting structure is disposed is not limited to the facing electrode forming device 22. It is acceptable that the base board converting structure is disposed in, for example, an exit of the functional layer forming device 21 (illuminating layer forming device 27) and an entrance of the sealing device 23. In the present embodiment in which the base board is processed while a surface to be processed is disposed upwardly in a plurality of steps, it is possible to convert the base board collectively for devices which are disposed therebefore and thereafter by disposing a base board converting structure in a device (facing electrode forming device 22) for processing a base board of which surface is disposed downwardly; thus, it is possible to realize a smaller device.

Here, in the above manufacturing device 20, it is preferable that a space where the base board to be processed is disposed is in an atmosphere in which a water and an oxygen is eliminated. For example, it is preferable that the space is in an inert gas atmosphere such as nitrogen atmosphere and argon atmosphere. By doing this, it is possible to prevent the layer which is formed on the base board from being deteriorated due to the oxidization or the like.

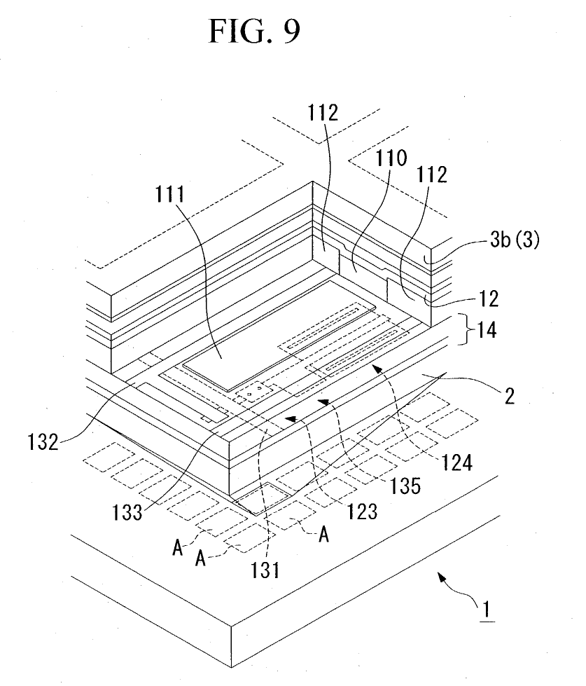

FIG. 9 shows an embodiment of an active matrix display device (organic EL display device) having the organic EL device in which the electrooptic device according to the present invention is used. Here, the active matrix display device is provided with the organic EL device which is manufactured by using the above manufacturing device 20 as an illuminating element. Also, the display device 1 employs an active driving method which uses a TFT.

The display device 1 is made by stacking a circuit element section 14 which includes a TFT as a circuit element, a functional layer 110 which includes an illuminating layer, a cathode 12, and a sealing section 3 on the base board 2 successively.

In the present embodiment, a glass base board is used for the base board 2. In the present embodiment, various base boards which can be commonly used in an electrooptic device and a circuit base board such as a silicon base board, a silica base board, a ceramics base board, a metal base board, a plastic base board, a plastic film base board can be used instead of the glass base board.

On the base board 2, a plurality of pixel areas A as an illuminating area are disposed in a matrix manner. In case of a color display operation, for example, a pixel area A which corresponds to colors such red (R), green (G), and blue (B) is disposed in a predetermined arrangement.

In each pixel area A, a pixel electrode 111 id disposed. A signal line 132, a power supply line 133, a scanning line 131, and other scanning lines which is not shown in the drawing for the pixel electrodes are disposed near the pixel electrode 111. For a plan shape of the pixel electrode A, any shapes such as a circle and an oval can be used instead of a rectangle shown in the drawing.

Also, the sealing section 3 prevents a water and an oxygen from invading thereto so as to avoid the oxidization of the cathode 12 or the functional layer 110. The sealing section 3 contains a sealing resin which is applied to the base board 2 and a sealing base board 3b (sealing can) which is attached to the base board 2. For a member for the sealing resin, for example, a thermosetting resin or an ultra-violet ray curable resin are used. In particular, an epoxy resin which is a thermosetting resin is used preferably. The sealing resin is applied in circular manner around a marginal region of the base board 2. The sealing resin is applied by, for example, a device such as a micro-dispenser. The sealing base board 3b is a glass member or a metal member. The base board 2 and the sealing base board 3b are attached via the sealing resin.

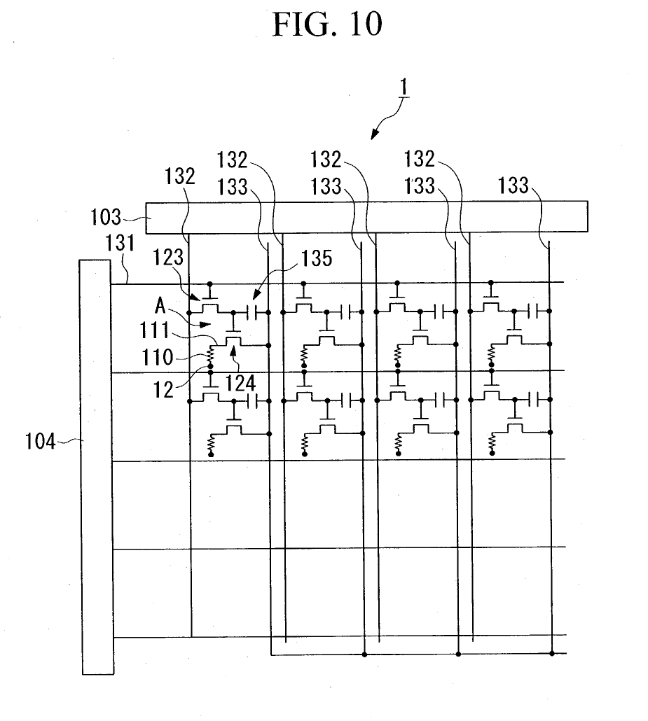

FIG. 10 shows a circuit structure in the above display device 1.

In FIG. 10, a plurality of scanning lines 131, a plurality of signal lines 132 which expand in a direction which crosses the scanning lines 131, and a plurality of power supply lines 133 which expand in parallel with the signal lines 132 are disposed on the base board 2. Also, the above pixel area A is formed in each crossing point of the scanning line 131 and the signal line 132.

A shift register, a level shifter, a data driving circuit 103 which contains a video-line and an analogue switch are connected to the signal line 132. Also, a scanning driving circuit 104 which contains a shift register and a level shifter is connected to the scanning line 131.

In the pixel area A, there are provided with a first TFT 123 for switching in which the scanning signal is supplied to a gate electrode via the scanning line 131, a retaining capacity 135 for retaining an image signal which is supplied from the signal line 132 via the TFT 123, a second TFT 124 for driving in which the image signal which is retained in the retaining capacity 135 is supplied to the gate electrode, and a pixel electrode 111 (anode) to which the driving electricity flows in from the power supply line 133 when the pixel electrode 111 (anode) is connected to the power supply line 133 electrically via the TFT 124, and a functional layer 110 which is sandwiched between the pixel electrode 111 and the facing electrode 12 (cathode). The functional layer 110 contains an organic EL layer as an illuminating layer.

When the scanning line 131 is driven and the first TFT 123 is turned on, an electric potential in the signal line 132 is retained in the retaining capacity 135. Conductance in the second TFT 124 is determined according to the condition of the retaining capacity 135. Also, an electricity flows into the pixel electrode 111 from the power supply line 133 via a channel in the second TFT 124. Furthermore, an electricity flows into the facing electrode 12 (cathode) through the functional layer 110. The functional layer 110 illuminates according to the electricity under the temporary condition.

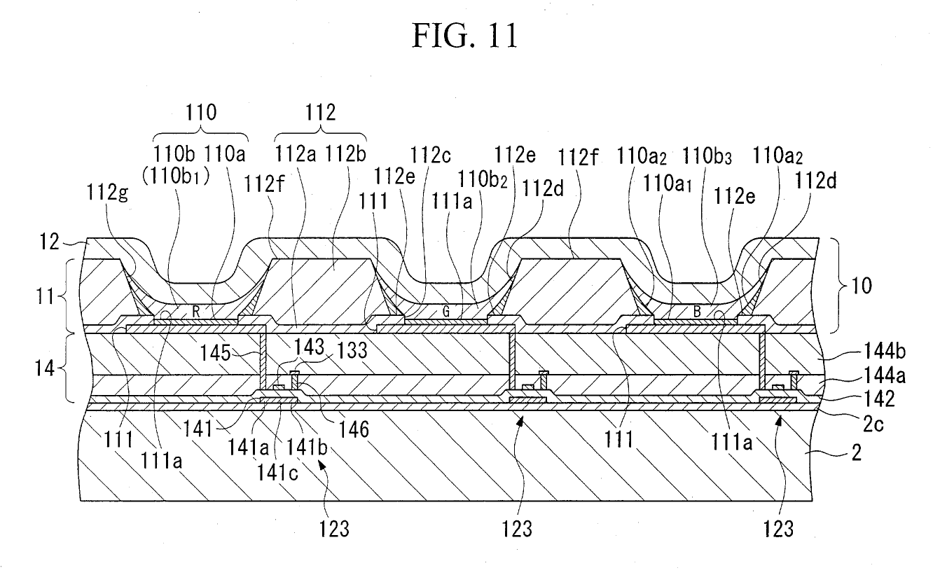

Next, FIG. 11 is an enlarged view of cross section of the display area in the display device 1. In FIG. 11, three pixel areas A are shown. On the base board 2 of the display device 1, the circuit element section 14 on which circuits such as TFT are formed and the illuminating element section 11 on which the functional layer 110 is formed, and a cathode 12 are layered alternately.

In the display device 1, a light which is emitted from the functional layer 110 toward the base body 2 is transported through the circuit element section 14 and the base body 2 so as to be emitted beneath the base body 2 (toward an observer). Also, the light which is emitted from the functional layer 110 opposite to the base body 2 is reflected by the cathode 12 an transported through the circuit element section 14 and the base body 2 so as to be transported beneath the base body 2 (toward an observer).

Here, if a transparent cathode 12 is used, it is possible to emit a light which illuminates from the cathode. For such a transparent member, ITO, Pt, Ir, Ni, or Pd can be used. 75 nm thickness is preferable. More preferably, thinner thickness is preferred.

A base protecting layer 2c made from a silicon oxide layer is formed on the base board 2 in the circuit element section 14. An island semiconductor layer 141 made from a polysilicon is formed on the base protection layer 2c. Here, a source area 141a and a drain area 141b are formed on the semiconductor layer 141 by high-density P-ion implanting. Here, an area where P is not introduced is a channel area 141c.

Furthermore, a transparent gate insulating layer 142 which covers the base protection layer 2c and the semiconductor layer 141 is formed in the circuit element section 14. A gate electrode 143 (scanning line 101) made from a metal such as Al, Mo, Ta, Ti, and W is formed on the base insulating layer 142. A transparent first inter-layer insulating layer 144a an a second inter-layer insulating layer 144b are formed on the gate electrode 143 and the gate insulating layer 142. The gate electrode 143 is disposed in a position which corresponds to a channel area 141c in the semiconductor layer 141.

Also, contact holes 145 and 146 through the first and second inter-layer insulating layer 144a and 144b so as to be connected to the source area in the semiconductor layer 141 and the drain area of the semiconductor layer 141 respectively are formed.

A transparent pixel electrode 111 made of an ITO, etc., is formed on the second inter-layer insulating layer 144b in a predetermined shape by a patterning operation. One of the of the contact hole 145 is connected to the pixel electrode 111.

Also, the contact hole 146 is connected to the power supply line 133.

By doing this, a driving thin film transistor 123 which is connected to each pixel electrode 111 is formed in the circuit element section 14.

Here, although the retaining capacity 135 and the switching thin film transistor 124 is formed which are explained previously are formed in the circuit element section 14, these are not shown in FIG. 11.

The illuminating element section 11 is formed mainly by the functional layer 110 which is layered on a plurality of pixel electrode 111, a bank section 112 which is disposed between each of the pixel electrode and the functional layer 110 so as to separate each of the functional layer 110, and the cathode 12 (second electrode) which is formed on the functional layer 110. The organic EL device such as an illuminating element is formed by the pixel element (first element) 111, the functional layer 110, and the cathode (second electrode).

Here, the pixel electrode 111 is formed by, for example, a metal such as ITO. The pixel electrode 111 is formed in approximately rectangular in plan view by a patterning operation. Thickness of the pixel electrode 111 should preferably be in a range of 50 to 200 nm, in particular, nearly 150 nm is more preferable. A bank section 112 is disposed between each of the pixel electrodes 111a and 111.

As shown in FIG. 11, bank section 112 is formed by an inorganic bank layer 112a (first bank layer) which is disposed near the base body 2 and an organic bank layer 112b (second bank layer) which is disposed farther from the base body 2 thereon.

The inorganic bank layer and the organic bank layer (112a and 112b) are formed so as to overlap a periphery of the pixel electrode 111. In a plan view, the periphery of the pixel electrode 111 and the inorganic bank layer 112a are overlapping. Also, the organic bank layer 112b has the same structure; thus, the bank layer 112 overrides apart of the pixel electrode 111. Also, the inorganic bank layer 112a is formed in more center of the pixel electrode 111 than the organic bank layer 112b. By doing this, each of first layer section 112e in the inorganic bank layer 112a is formed inside of the pixel electrode 111. By doing this, a lower opening section 112c is disposed so as to correspond to a position of the pixel electrode 111.

Also, an upper opening section 112d is formed in the organic bank layer 112b. The upper opening section 112d is disposed so as to correspond to positions of the pixel electrode 111 and the lower opening section 112c. As shown in FIG. 3, the upper opening section 112d is formed so as to be larger than the lower opening section 112c and narrower than the pixel electrode 111. Also, there is a case in which the position of an upper part of the upper opening section 112d and an end of the pixel electrode 111 are approximately the same. In such a case, as shown in FIG. 11, cross section of the upper opening section 112d in the organic bank layer 112b is diagonal.

In addition, an opening section 12 which penetrates through the inorganic bank layer 112a and the organic bank layer 112b is formed in the bank section 112 by communicating through the lower opening section 112c and the upper opening section 112d.

Also, it is preferable that the inorganic bank layer 112a be an inorganic member such as SiO₂, or TiO₂. Thickness of the inorganic bank layer 112a should preferably be in a range of 50 to 200 nm, more particularly, 150 nm. If the thickness is less than 50 nm, the thickness of the inorganic bank layer 112a is thinner than a positive hole implantation/transportation layer which is to be explained; thus, it is not preferable because it is impossible to realize flatness of the positive hole implantation/transportation layer. Also, if the inorganic bank layer 112a is thicker than 200 nm, a gap made by the lower opening section 112c becomes larger; thus, it is impossible to realize flatness of an illuminating layer which is layered on the positive hole implantation/transportation layer to be explained later. Thus, it is not preferable.

Furthermore, the organic bank layer 112b is made from a heat-resistive and solution-resistive resist such as acryl resin, and polyimide resin. It is preferable that the thickness of the organic bank layer 112b be in a range of 0.1 to 3.5 μm, in particular, nearly 2 μm. If the thickness is less than 0.1 μm, the organic bank layer 112b becomes thinner than the total thickness of the positive hole implantation/transportation layer which is to be explained and the illuminating layer; thus, it is not preferable because there is a concern that the illuminating layer spills over the upper opening section 112d. Also, if the thickness is larger than 3.5 μm, a gap made by the upper opening section 112d becomes larger; thus, it is not preferable because it does not yield a step coverage by the cathode 12 which is formed on the organic bank layer 112b. Also, if the organic bank layer 112b is thicker than 2 μm, it is possible because it is possible to enhance insulation to the driving thin film transistor 123.

Also, an area which indicates lyophilic characteristics and an area which indicates water-repellant characteristics are formed in the bank section 112.

The area which indicates lyophilic characteristics are the first layered section 112e in the inorganic bank layer 112a and a surface 111a of the pixel electrode 111. Surfaces of these areas are processed to be lyophilic by performing plasma processing operation using a processing gas such as oxygen. The area which exhibits water-repellant characteristics are the wall surface of the upper opening section 112d and an upper surface 112f of the organic bank layer 112. Surfaces of these areas are processed by a plasma processing operation by using a processing gas such as tetrafluoromethane (water-repellant).

As shown in FIG. 11, the functional layer 110 is formed by a positive hole implantation/transportation layer 110a which is layered on the pixel electrode 111 and an illuminating layer 110b which is formed next to the positive hole implantation/transportation layer 110a. Here, it is acceptable that other functional layer having function such as an electron implantation transportation layer is further formed next to the illuminating layer 110b. For example, it is possible to form an electron transporting layer.

The positive hole implantation/transportation layer 110a has a function for implant a positive hole in to the illuminating layer 110b and for transport the positive hole in the positive hole implantation/transportation layer 110a. By disposing such positive hole implantation/transportation layer 110a between the pixel electrode 111 and the illuminating layer 110b, superior characteristics in the illuminating layer 110b such as illuminating efficiency and the product life can be obtained. Also, the positive hole which is implanted from the positive hole implantation/transportation layer 110a and an electron which is implanted from the cathode 12 are united again in the illuminating layer 110b; thus, illuminating function can be realized.

The positive hole implantation/transportation layer 110a is formed by a flat section 110a1 which is formed in the lower opening section 112c on the pixel electrode surface 111a and a peripheral section 110a2 which is formed in the upper opening section 112d on the first layer section 112e of the inorganic bank layer. Also, the positive hole implantation/transportation layer 110a is formed only between the inorganic bank layers 110a (lower opening section 110c) on the pixel electrode 111; thus, such a disposition may depend on its structure, and it is acceptable for the positive hole implantation/transportation layer 110a to be formed only on the flat section).

Thickness of the flat section 110a1 is constant, for example, within a range of 50 to 70 nm.

When the periphery section 110a2 is formed, the periphery section 110a2 is disposed on the first layer section 112e and contacts a wall surface of the upper opening section 112d, such as the organic bank layer 112b closely. Also, the thickness of the periphery section 110a2 is thin near the surface 111a of the electrode and increases in a direction away from the surface 111a of the electrode. The thickness of the periphery section 11a2 is the thickest near the wall surface of the lower opening section 112d.

The periphery section 110a2 has various shapes because the positive hole implantation/transportation layer 110a is formed by ejecting a first composition including a positive hole implantation/transportation layer forming member and polar solution in the opening section 112 and removing the polar solution, the polar solution evaporates mainly on the first layer section 112e on the inorganic bank layer; thus, the positive hole implantation/transportation layer forming member is condensed and extracted collectively on the first layer section 112e.

Also, the illuminating layer 110b is formed on the flat section 110a1 of the positive hole implantation/transportation layer 110a and the periphery section 110a2. The thickness of the illuminating layer 110b is in a range of 50 to 80 nm on the flat section 112a1.

The illuminating layer 110b has three colors such as a red illuminating layer 110b1 for illuminating in red (R), a green illuminating layer 110b2 for illuminating in green (G), and a blue illuminating layer 110b3 for illuminating in blue (B). Illuminating layer 110b1 to 110b3 are disposed in a stripe.

As explained above, the periphery section 110a2 of the positive hole implantation/transportation layer 110a contacts the wall surface (organic bank layer 112b) of the upper opening section 112d closely; therefore, the illuminating layer 110b does not contact the organic bank layer 112b directly. Therefore, it is possible to prevent water which is contained as an impurity in the organic bank layer 112b from being migrating to the illuminating layer 110b by using the periphery section 112a2; thus, it is possible to prevent the illuminating layer 110b from being oxidized.

Also, the periphery section 110a2 having non-uniform thickness is formed on the first layer section 112e in the inorganic bank layer. Thus, the periphery section 110a2 is insulated from the pixel electrode 111 by the first layer section 112e. Therefore, the positive hole is not implanted from the periphery section 110a2 into the illuminating layer 110b. By doing this, electric current flows from the pixel electrode 111 only the flat section 112a1; thus, it is possible to transport the positive hole from the flat section 112a1 to the illuminating layer 110b uniformly. Therefore, it is possible to illuminate only a central area of the illuminating layer 110b and equalize the illumination amount in the illuminating layer 110b.

Also, the inorganic bank layer 112a extends in more inwardly of the pixel electrode 111 by the inorganic bank layer 112b. Thus, it is possible to trim shape of the connecting part of the pixel electrode 111 and the flat section 110a1 by the inorganic bank layer 112a; therefore, it is possible to reduce non-uniformity of illumination intensity between the illuminating layers 110b.

Furthermore, the surface 111a of the pixel electrode 111 and the first layer section 112e of the inorganic bank layer indicate the lyophilic characteristics; therefore, the functional layer 110 closely contacts the pixel electrode 111 and the inorganic bank layer 112a uniformly. Thus, the functional layer 110 does not become extremely thin on the inorganic bank layer 112a; therefore, it is possible to prevent a short-circuit from occurring between the pixel electrode 111 and the cathode 12.

Also, an upper surface 112f of the organic bank layer 112b and the wall surface of the upper opening section 112d indicate water-repellant characteristics; therefore, contact between the functional layer 110 and the organic bank layer 112b is reduced; thus, there is not a case in which the functional layer 110 is formed such that the functional layer 110 spills over the opening section 112g.

For a member for forming a positive hole implantation/transportation layer, for example, a mixture of polythiophene derivative such as polyethylene dioxythiophene and polystyrene sulfonic acid can be used. For a member for forming the illuminating layer 110b, polyfluorene derivative such as compositions 1 to 5, or (poly-)p-phenylene vinylene derivative, polyphenylene derivative, polyfluorene derivative, polyvinyl carbazole, polythiophene derivative can be used. Also, above polymer member can be used by doping a member such as perylene dye, coumarin dye, rhodamine dye, rubrene, perylene, 9,10-diphenylanthracene, tetraphenylbutadiene, Nile-red, coumarin 6, quinacridone.

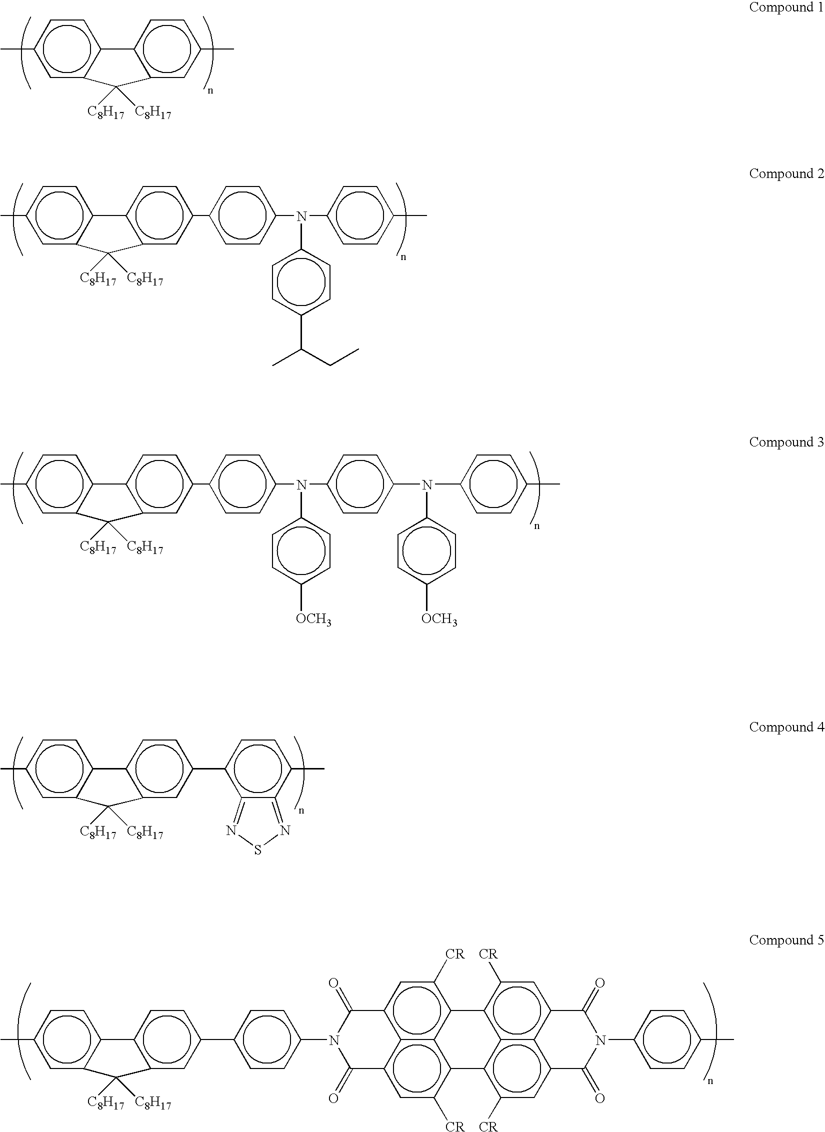

A cathode 12 is formed on an entire surface of the illuminating element 11. The cathode 12 is coupled with the pixel electrode 111 so as to flow electric current to the functional layer 110. The cathode 12 can be formed by layering a calcium layer and an aluminum layer. In such a case, it is preferable to dispose the calcium layer or the aluminum layer having low work function on the cathode which is disposed near the illuminating layer. In particular, in the present embodiment, the cathode 12 works for implanting an electron into the illuminating layer 110b by contacting the illuminating layer 110b directly. Also, in a lithium fluoride, a LiF can be formed between the illuminating layer 110b and the cathode 12 so as to illuminate efficiently.

Here, the red illuminating layer 110b1 and the red illuminating layer 110b2 are not limited to a lithium fluoride; thus, it is acceptable to use another member. Therefore, in such a case, a layer made of the lithium fluoride is formed only in the blue (B) illuminating layer 110b3 and other members are layered in the red illuminating layer 110b3 and the green illuminating layer 110b2. Also, it is acceptable that only the calcium be formed on the red illuminating layer 110b1 and the green illuminating layer 110b2 instead of the lithium fluoride.

Here, thickness of the lithium fluoride is preferably in a range of 2 to 5 nm, in particular, near 2 nm. Also, the thickness of the calcium is preferably in a range of 2 to 50 nm.

Also, the aluminum which forms the cathode 12 reflects the light which is emitted from the illuminating layer 110b toward a base body 2; therefore, the aluminum for forming the cathode 12 should preferably be made of an Al layer, Ag layer, and a layered structure of Al and Ag. Also, the thickness should preferably be in a range between 100 to 1000 nm, in particular, near 200 nm.

Furthermore, it is acceptable that a protection layer made of metal such as SiO, SiO₂, SiN be disposed on the aluminum for preventing the oxidization.

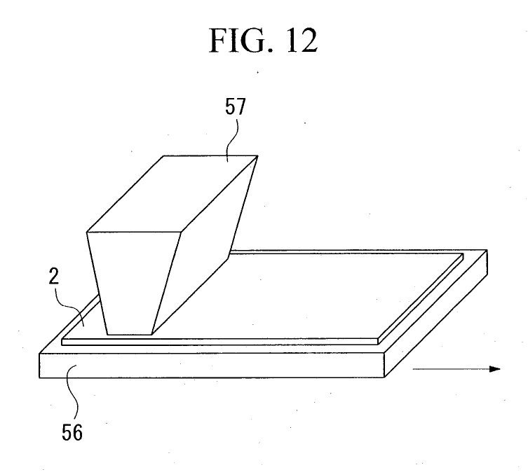

Next, a manufacturing method for an organic EL device and an organic EL display device by using the manufacturing device 20 for the organic EL device shown in FIG. 3 is explained in detail with reference to FIGS. 12 to 16.

The manufacturing method for an organic EL device according to the present invention includes steps such as (1) a plasma processing step, (2) a positive hole implantation/transportation layer forming step, (3) an illuminating layer forming step, (4) a facing electrode (cathode) forming step, and (5) a sealing step. Here, the manufacturing method is not limited only to the above method. It is acceptable that other steps are omitted or added according to necessity.

Also, a TFT is formed on the base board 2 as a circuit element. Also, a pixel electrode 11 and a bank section 112 are formed on the base board to which are projected on such a base board 2 in the manufacturing device 20.

(1) Plasma Processing Operation

A plasma processing operation is performed for purposes of activating a surface of the pixel electrode 111 and performing a surface processing for the bank section 112. In particular, purposes in the activating operation are to clean the pixel electrode 111 (ITO) and adjusting operating functions. Furthermore, the activating operation performs a lyophilic operation on a surface of the pixel electrode 111 and a water-repellant operation on a surface of the bank section 112.

The plasma processing operation can be categorized into (1)-1 a preliminary heating process, (1)-2 an activating process (lyophilic process), (1)-3 a water-repellant process, and (1)-4 a cooling process. Here, the plasma processing operation is not limited to these categories and process therein can be omitted or added according to necessity.

The general process using the plasma processing device 25 shown in FIG. 4 is explained.

A preliminary heating process is performed in the preliminary heating processing chamber 51 shown in FIG. 4. A base body 2 which is handled from the bank section forming process is heated at a predetermined temperature in the preliminary heating processing chamber 51.

A lyophilic process and a water-repellant process are performed after the preliminary heating process. That is, the base body is transported to a first plasma processing chamber 52 and the second plasma processing chamber 53 subsequently. The plasma processing operation is performed to the bank section 112 in each chamber so as to be lyophilic. A water-repellant process is performed after the lyophilic processing. The base body is transported to a cooling processing chamber after the water-repellant process and the base body is cooled down to room temperature in the cooling processing chamber 54. The base body is transported to a next process so as to perform a positive hole implantation/transportation layer forming process by the handling device after the cooling processing operation.

Each process is explained in detail as follows.

(1)-1 Preliminary Heating Process

A preliminary heating process is performed in the preliminary heating processing chamber 51. The base body 2 including the bank section 112b is heated to a predetermined temperature in the preliminary heating processing chamber 51.

The base body 2 is heated by a heater which is attached to a stage for mounting a base body thereon in the preliminary heating processing chamber 51 so as to heat the base body 2 and the stage. For a heating method, other method can be employed.

The base body 2 is heated in a temperature range of, for example, 70° C. to 80° C. in the preliminary heating processing chamber 51. Such a temperature is employed in a next process such as a plasma processing operation. The purpose for employing such a temperature is to heat the base body 2 so as to correspond a conditions in a next process and reduce unevenness in the temperature of the base body 2.

If there is no preliminary heating process, the base body 2 is heated in the above temperature. Under such a condition, the plasma processing operation is performed to the base body 2 from the beginning to the end with a continuous variation of the temperature. There is a possibility that the characteristics may become uneven when the plasma processing operation is performed while the temperature of the base body changes. Therefore, the preliminary heating process is performed so as to maintain the process conditions constant and realize uniform characteristics.

Here, when the lyophilic process and a water-repellant process are performed under conditions that the base body 2 is mounted on a sample stage in the first plasma processing device 52 and the second plasma processing device 53 in the plasma processing operation, it is preferable that the preliminary heating process temperature should approximately be the same as that of the sample stage 56 in which lyophilic processes and the water-repellant processes are performed.

Here, the preliminary heating process is performed to the base body 2 in a temperature such as 70° C. to 80° C. to which the temperature of the sample stage in the first plasma processing device 52 and the second plasma processing device 53 increase. By doing this, the plasma processing condition is approximately the same between before and after the plasma processing operation even if the plasma processing operation is performed on numerous base bodies continuously. By doing this, it is possible to maintain the condition for a surface processing of the base body 2; thus, it is possible to equalize the wettability of the bank section 112 against the composition. Therefore, it is possible to manufacture a display device having a constant quality.

Also, by performing a preliminary heating process in advance, it is possible to shorten time for processing in the plasma processing operation which is performed later.

(1)-2 Activating Process

An activating process is performed in the first plasma processing chamber 52. The activating process includes processes such as adjusting and controlling a work functions in the pixel electrode 111, cleaning a surface of the pixel electrode, and performing a lyophilic process for a surface of the pixel electrode.

In the lyophilic process, a plasma process (O₂ plasma process) using oxygen as a process gas in an atmosphere. In FIG. 12, the plasma processing operation is graphically shown. As shown in FIG. 12, the base body 2 including the bank section 112 is mounted on the sample stage 56 having a heater thereinside. A plasma discharging electrode 57 is disposed on an upper surface of the base body 2 so as to face the base body 2 having a gap distance such as 0.5 to 2 mm. The base body 2 is heated by the sample stage 56. Simultaneously, the sample stage 56 is transported in a direction which is indicated in FIG. 7 in a predetermined speed. During that period, oxygen in a plasma-state is emitted to the base body 2.

For O₂ plasma processing, conditions such as 100 to 800 kW of plasma power, 50 to 100 ml/min of oxygen gas flow, 0.5 to 10 mm/sec of board transportation speed, 70 to 90° C. of base body temperature are acceptable. The sample stage 56 performs the heating operation so as to mainly maintain the temperature in the base body to which the preliminary heating process is performed.

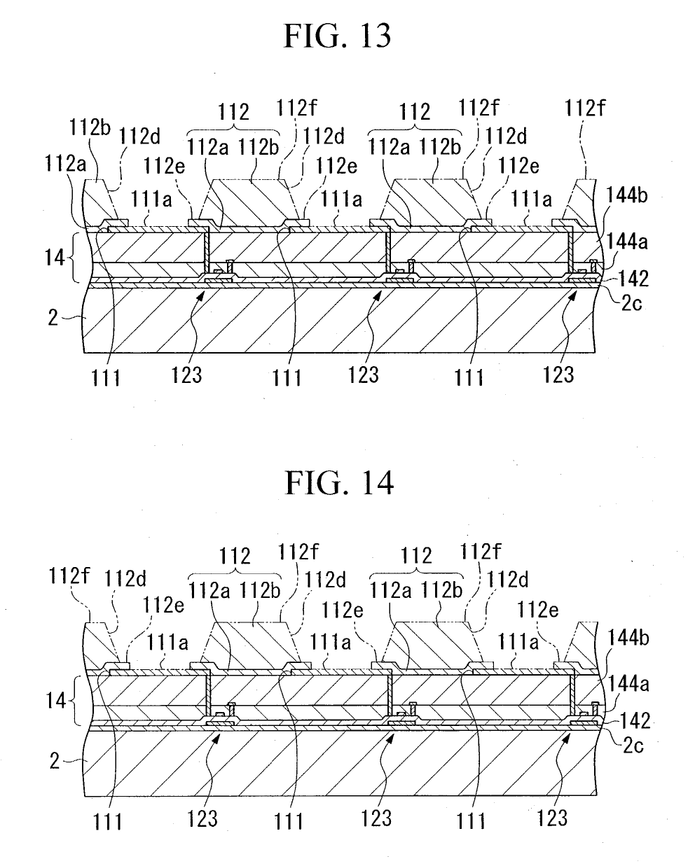

By the O₂ plasma processing, as shown in FIG. 13, lyophilic process is performed to the surface 111a of the pixel electrode 111, the first layer section 112e in the inorganic bank layer 112a, a wall surface of the upper opening section 112d and an upper surface 112f in the organic bank layer 112b. By the lyophlic process, a hydroxyl group is introduced to each surface; thus, lyophilic characteristics is given.

In FIG. 14, a broken line indicates the area to which the lyophilic process is performed.

Here, the O₂ plasma process not only gives lyophilic characteristics but also cleans the pixel electrode such as ITO and adjusts the work functions compatibly.

(1)-3 Water-Repellant Process

Next, a plasma process (CF₄ plasma process) as a water-repellant process is performed in the second plasma processing chamber 53 using a process gas such as tetrafluoromethane in an atmosphere. The internal structure of the second plasma processing chamber 53 is the same as that of the first plasma processing chamber 52 shown in FIG. 12. That is, the base body 2 is heated by the sample stage, and during that period, the base body 2 and the sample stage are transported at a predetermined speed. During that period, the tetrafluoromethane in a plasma state is emitted to the base body 2.

CF₄ plasma process can be performed under conditions such as 100 to 800 kW of plasma power, 50 to 100 ml/min of fluoromethane gas flow, 0.5 to 10 mm/sec of base body transporting speed, 70° C. to 90° C. of base body temperature. The heating stage heats the base body 2 for a purpose of maintaining the temperature of the base body to which the preliminary heating process is performed similarly to a case of the first plasma processing chamber 52.

Here, a process gas is not limited to a tetrafluoromethane. Other fluorocarbon gas can be used for a process gas.

By performing CF₄ plasma process, as shown in FIG. 14, lyophilic process is performed to a wall surface of the upper opening section 112d and an upper surface 112f of the organic bank layer. By the lyophilic process, a fluorine group is introduced to each surface; thus, water-repellant characteristics is given there. In FIG. 14, an area which indicates the water-repellant characteristics is shown by a two-dot broken line. Lyophilic process can be performed easily on organic members such as acrylic resin which forms the organic bank layer 112b and polyimide resin by emitting a fluorocarbon in plasma state. There is a feature in that the fluorine member can be formed more easily on these organic members by performing the O₂ plasma process. Such a feature is particularly effective in the present embodiment.

Here, the surface 111a of the pixel electrode 111 and the first layer section 112e of the inorganic bank layer 112a are influenced by the CF₄ plasma process. However, the wettability will not be influenced. In FIG. 14, an area which exhibits lyophilic properties is indicated by a one-dot broken line.

(1)-4 Cooling Process

In a cooling process, the base body 2 which is heated in the plasma process is cooled to an operational temperature by using the cooling processing chamber 54. This process is performed so as to cool the base body 2 to an operational temperature employed in an ink jet process (liquid drop ejecting process) which is performed later.

The cooling processing chamber 54 has a plate for disposing the base body 2. In the plate, a water cooling device is built therein so as to cool the base body 2.

Also, by cooling the base body after the plasma process at room temperature of a predetermined temperature (for example, an operational temperature in which the ink jet process is performed), the temperature in the base body 2 becomes constant in the next process such as the positive hole implantation/transportation forming process; thus, it is possible to perform a next process without temperature fluctuation of the base board 2. By arranging the cooling process, it is possible to form a member which is ejected from an ejecting device according to ink jet method or the like uniformly.

For example, when a first composition including a member for forming a positive hole implantation/transportation is ejected, it is possible to eject the first composition in an uniform volume continuously; thus, it is possible to form the positive hole implantation/transportation layer uniformly.

In the above plasma process, the O₂ plasma process and the CF₄ plasma process are performed to the organic bank layer 112b and the inorganic bank layer 112a both of which are made from different member consequently, it is possible to dispose a lyophilic area and a water-repellant area on the bank section 112 easily.

Also, for an above plasma processing device, a device which works under vacuum conditions can be used instead of a device which works under atmospheric pressure conditions.

(2) Positive Hole Implantation/Transportation Layer Forming Process

Next, a positive hole implantation/transportation layer is formed on an electrode (here, pixel electrode 111) in an illuminating layer forming process.

In the positive hole implantation/transportation layer forming process, a first composition (composition) including a positive hole implantation/transportation layer forming member is ejected on the surface 111a of the pixel electrode according to liquid drop ejecting method (ink jet method). After that, a dry process and a thermal process are performed so as to form a positive hole implantation/transportation layer 110a on the pixel electrode 111 and the inorganic bank layer 112a. Here, the inorganic bank layer 112a on which the positive hole implantation/transportation layer 110a is formed is called the first layer section 112e.

Processes thereafter including the positive hole implantation/transportation layer forming process should preferably be conducted in an atmosphere without water and oxygen. For example, an atmosphere under a nitrogen atmosphere or argon atmosphere is preferable.

Here, there is a case in which the positive hole implantation/transportation layer 110a is not formed on the first layer section 112e. That is, there is a case in which the positive hole implantation/transportation layer is formed only on the pixel electrode 111.

Manufacturing method according to the ink jet method is as follows.

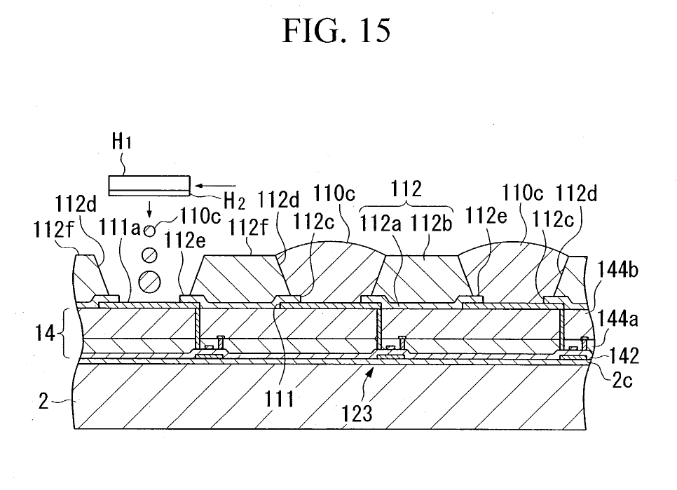

As shown in FIG. 15, the first composition including the positive hole implantation/transportation layer forming member is ejected from a plurality of nozzles which are formed in the ink jet head H1. Here, the first composition is replenished in each pixel area A by scanning the ink jet head. Such an operation can be performed by scanning the base body 2. Furthermore, the composition can be replenished by moving the ink jet head and the base body 2 relatively. Here, in the processes using the ink jet head hereafter are performed in the same manner as the above explanation.

An ejection operation is performed by the ink jet head as follows. That is, an ejection nozzle H2 which is formed in the ink jet head H1 is disposed so as to face the electrode surface 111a and the first composition is ejected from the nozzle H2. A bank 112 which separates the opening section 112c is formed around the pixel electrode 111. The ink jet head H1 is disposed so as to face the pixel electrode surface 111a which is disposed in a lower opening section 112c. The a first composition drop 110c of which amount per one drop is controlled is ejected to the electrode surface 111a by moving the ink jet head H1 and the base body 2 relatively. The liquid drops which are ejected into an opening section 112g can be six drops to 20 drops.

For the first composition which is used here, for example, a composition which is made by solving a mixture of polythiophene derivative such as polyethylene dioxythiophene (PEDOT) and polystyrene sulfonic acid (PSS) in a polar solvent can be used. For a polar solvent, for example, isopropyl alcohol (IPA), n-butanol, γ-butyrolactone, N-methylpyrrolidone (NMP), 1,3-dimethyl-2-imidazolidinone (DMI) and its derivative, glycol esters such as arbitol acetate, and butylcarbitol acetate can be named.

For more specific structure of the first composition, conditions such as PEDOT/PSS mixture (PEDOT/PSS=1:20):12.52 weight %, PSS:1.44 weight %, IPA:10 weight %, NMP:27.48 weight %, DMI: 50 weight % can be proposed. Here, the viscousity of the first composition should preferably be nearly 2 to 20 Ps, in particular, 4 to 15 cPs.

By using the above first composition, it is possible to perform an ejection operation stably without clogging the ejection nozzle H2.

Here, a common member for a positive hole implantation/transportation layer forming member can be used for forming illuminating layers 110b1 to 110b3 for red (R), green (G), and blue (B). Also, a different member for a positive hole implantation/transportation layer forming member can be used.

As shown in FIG. 15, the liquid drop 110c of the ejected first composition spreads on the electrode surface 111a to which a lyophilic process is performed and the first layer section 112e finally so as to be replenished in the lower opening section 112c and the upper opening section 112d. If the liquid drop 110c of the first composition is ejected on the upper surface 112f which is outside of the predetermined ejection position, the first composition drop 110c does not spread on the upper surface 112f; the repelled first composition drop 110c is transported into the lower opening section 112c and the upper opening section 112d.

The first composition which is ejected on the electrode surface 111a is determined by factors such as size of the lower opening section 112c, a size of the upper opening section 112d, the thickness of the positive hole implantation/transportation layer, and the density of the positive hole implantation/transportation layer in the first composition, or the like.

Also, it is acceptable that the first composition drop 110c is ejected not only once but also a plural times onto a common electrode surface 111a. In such a case, it is acceptable that an amount of the first composition is equal in each time of ejection. Also, it is acceptable that an amount of the first composition differs in each time of ejection. Furthermore, it is acceptable that the first composition is ejected to different points in the electrode surface 111a in each time of ejection instead of ejecting the first TFT to a common point on the electrode surface 111a.

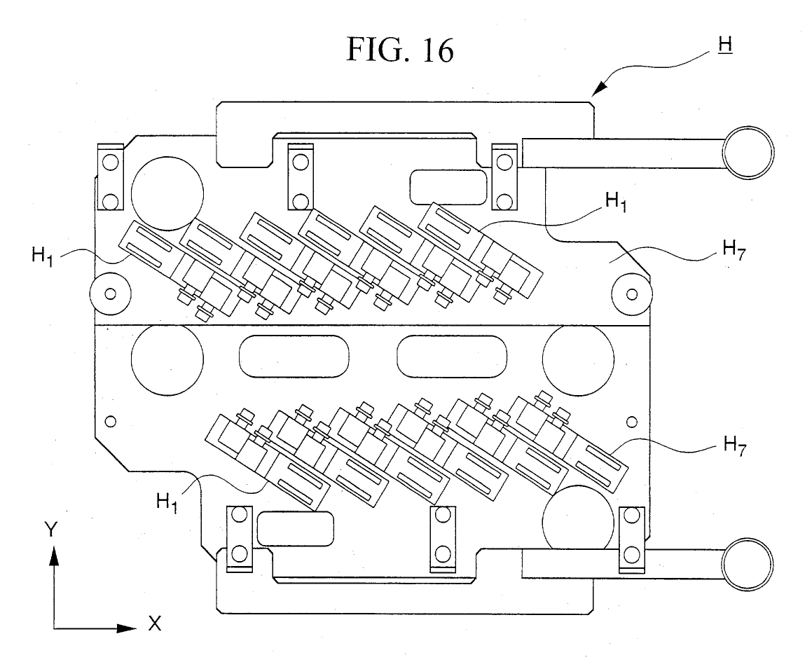

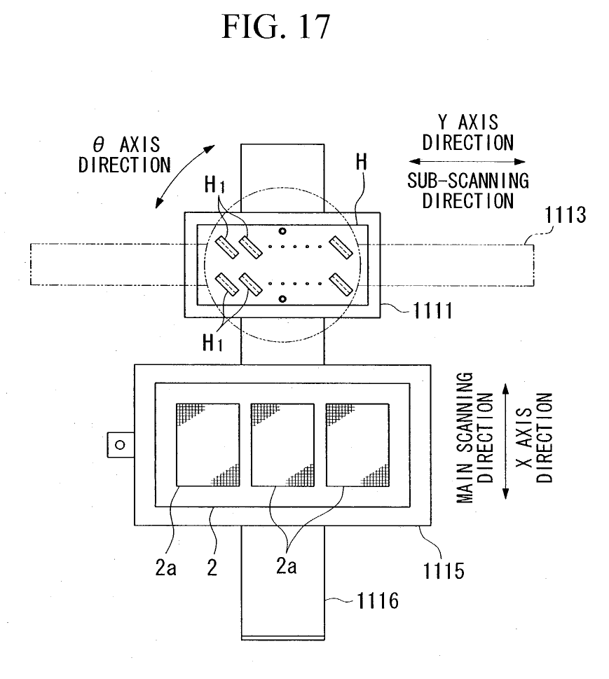

With respect to a structure of the inkjet head, it is possible to use an head H shown in FIG. 16. Furthermore, with respect to a disposition of the base board and the ink jet head, it is preferable to arrange a disposition shown in FIG. 17. In FIG. 17, reference numeral H7 indicates a supporting base board for supporting the ink jet head H1. A plurality of ink jet heads H1 are provided on the supporting base board H7.

A plurality of ejecting nozzles are provided on an ink ejecting surface (a facing surface to the base board) in the ink jet head H1 in two rows in a longitudinal direction of the head so as to have intervals in width direction of the head (for example 180 nozzles in one row, total 360 nozzles). Also, a plurality of the ink jet heads H1 are positioned on the supporting board 2 having a rectangular shape in plan view and supported under condition that the ejecting nozzle faces toward the base board and the ink jet head H1 is disposed diagonally in a predetermined angle with respect to the X-axis (or the Y-axis) in two rows in the X-axis direction so as to have predetermined intervals in the Y-axis direction (in FIG. 17, 6 pieces in one row, total 12 pieces).

Also, in the ink jet device shown in FIG. 17, reference numeral 1115 indicates a stage for mounting a base board 2. Reference numeral 1116 indicates a guide rail for guiding the stage 1115 in the X-axis direction (main scanning direction) in the drawing. Also, the head H can move in the Y-axis direction (sub-scanning direction) in the drawing by the guide rail 1113 via a supporting member 1111. Furthermore, the ink jet head H can rotate in a θ axis direction in the drawing. The head H can dispose the ink jet head H1 diagonally with respect to the main scanning direction by a predetermined angle. By doing this, by disposing the ink jet head diagonally with respect to the scanning direction, it is possible to make the nozzle pitch correspond to the pixel pitch. Also, by adjusting the inclining angle, it is possible to make the nozzle pitch correspond to any pixel pitch.

Also, in the base board 2 shown in FIG. 17, a plurality of chips are disposed on a mother board. That is, an area for one chip is equivalent to a display device. Here, three display areas 2a are formed, although the present invention is not limited to such a structure. For example, when the composition is applied to the display area 2a which is disposed in a left-hand side of the base board 2 in the drawing, the head H is moved to the left-hand side in the drawing via the guide rail 1113. Consequently, the base board 2 is moved upwardly in the drawing via the guide rail 1116 so as to apply the composition while scanning the base board 2.

Next, the head H is moved in the right-hand direction in the drawing so to apply the composition to a display area 2a in a center of the base board. Such an operation is performed to the display area 2a which is disposed in a right-hand end in the drawing similarly to the above operation.

Here, it is preferable that the head H shown in FIG. 16 and the ink jet device shown in FIG. 17 are used not only in the positive hole implantation/transportation layer forming step but also in the illuminating layer forming step.

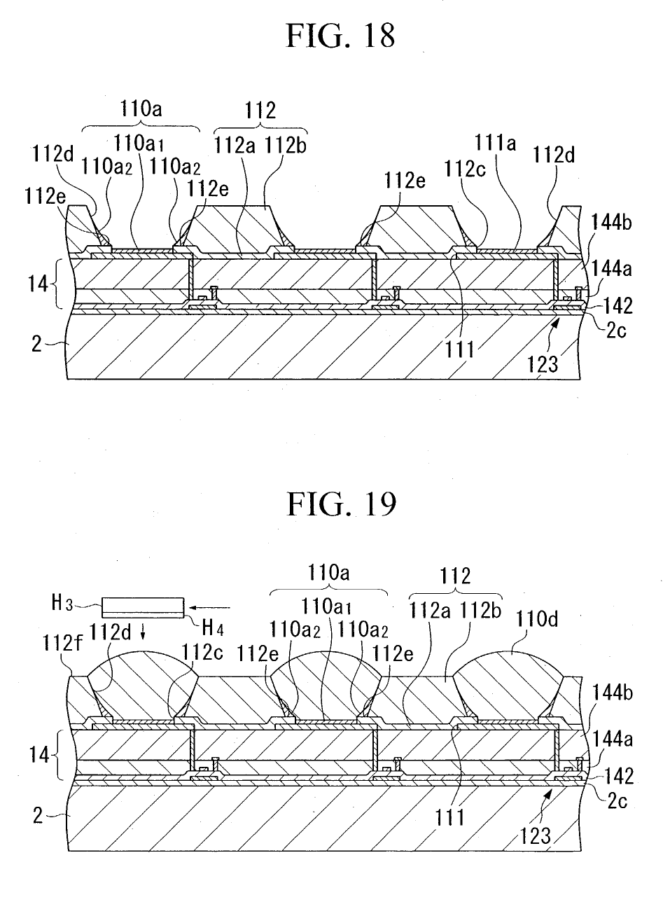

Next, a desiccating step is performed as shown in FIG. 18. By performing the desiccating step, the ejected first composition is desiccated, a polar solvent which is contained in the first composition is evaporated; thus, the positive hole implantation/transportation layer 110a is formed.

By performing the desiccating process, the polar solvent which is contained in the first composition drop 110c is evaporated mainly near an inorganic bank layer 112a and an organic bank layer 112b; thus, the member for forming the positive hole implantation/transportation layer is condensed and extracted according to the evaporation of the polar solvent.

By doing this, as shown in FIG. 19, a marginal region section 110a2 which is made of a member for forming the positive hole implantation/transportation layer is formed on the first layer section 112e. The marginal region section 110a2 contacts a wall surface (organic bank layer 112b) of the upper opening section 112d closely. Thickness of the marginal region section 110a2 is thin near the electrode surface 111a. Thickness of the marginal region section 110a2 is thick away from the electrode surface 111a, that is, near the organic bank layer 112b.

Also, simultaneously, the polar solvent is evaporated on the electrode surface 111a by the desiccating process; therefore, a flat section 110a1 which is made of a member for forming the positive hole implantation/transportation layer is formed on the electrode surface 111a. Evaporation speed of the polar solvent is approximately uniform on the electrode surface 111a; therefore, a member for forming the positive hole implantation/transportation layer is condensed uniformly on the electrode surface 111a; thus, a flat section 110a1 having a uniform thickness is formed.

By doing this, a positive hole implantation/transportation layer 110a having the marginal region section 110a2 and a flat section 110a1 is formed.

Here, other structure is acceptable in which the positive hole implantation/transportation layer is not formed in the marginal region section 110a2 but only in the electrode surface 111a.

The above desiccating process is performed under condition that, for example, pressure is approximately 133.3 Pa (1 Torr) in a nitrogen atmosphere in a room temperature. If the pressure is too low, it is not preferable because the first composition drop 110c is boiled. Also, if the temperature is higher than a room temperature, the evaporation speed of the polar solvent increases; thus, it is not possible to form a flat layer.

After performing the desiccating operation, it is preferable that the polar solvent and the water which remain in the positive hole implantation/transportation layer 110a are eliminated by performing a heating process under condition of 200° C. for approximately ten minutes in the nitrogen atmosphere, or more preferably in the vacuum condition.

In the above positive hole implantation/transportation layer forming step, the ejected first composition drop 110c is filled in the lower opening section 112c and the upper opening section 112d. On the other hand, the first composition is repelled on the organic bank layer 112b which is made water-repellant so as to be transported in the lower opening section 112c and the upper opening section 112d. By doing this, it is possible to fill the ejected first composition drop 110c in the lower opening section 112c and the upper opening section 112d reliably; thus, it is possible to form the positive hole implantation/transportation layer 110a on the electrode surface 111a.

(3) Illuminating Layer Forming Process

Next, an illuminating layer forming process comprises illuminating layer forming member ejecting process, and drying process. The illuminating layer forming process is performed by the illuminating layer forming device 27 shown in FIG. 4.

In the illuminating layer forming process, the second composition which includes the illuminating layer forming member is ejected on the positive hole implantation/transportation layer 110a by ink jet method (liquid drop ejecting method). After that, drying operation is performed so as to form the illuminating layer 110b on the positive hole implantation/transportation layer 110a.

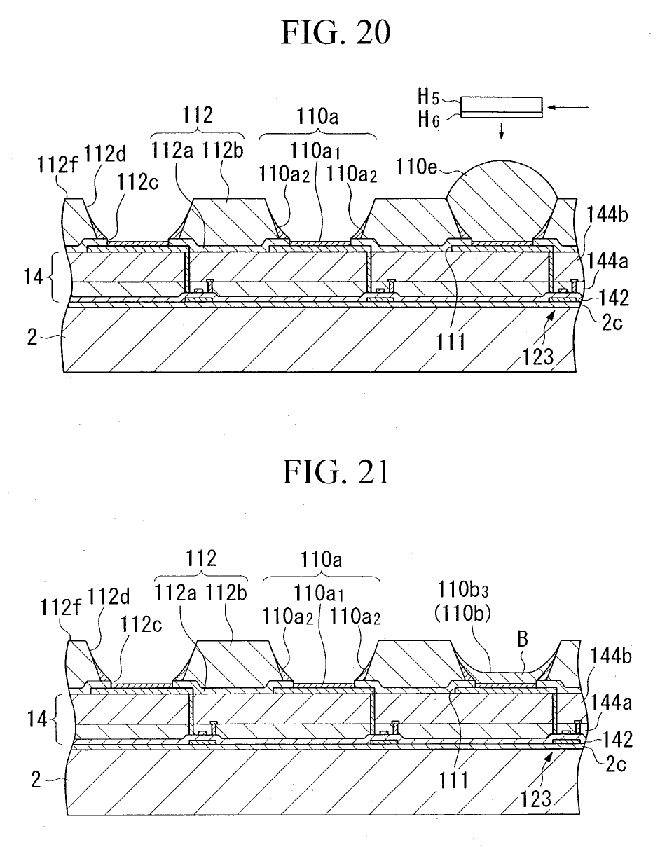

FIG. 20 is a general view for showing ejection method by using an ink jet. As shown in FIG. 20, the ink jet head H5 and the base body 2 are moved relatively. The second composition which includes the illuminating layer forming members for each color (for example, blue (B)) is ejected from the ejection nozzle H6 which is formed in the ink jet head.

In the ejection operation, the ejection nozzle is disposed so as to face the positive hole implantation/transportation layers 110a which are disposed in the lower opening section 112c and the upper opening section 112d. The second composition is ejected while the ink jet head H5 and the base body 2 are moved relatively. The amount per one time of the liquid ejection from the ejection nozzle H6 is controlled. In this way, the amount of the liquid (second composition liquid 110e) which is ejected from the ejection head. Thus, the second composition liquid 110e is ejected on the positive hole implantation/transportation layer 110a.

For an illuminating layer forming member, polyfluorene derivatives shown in the above compounds 1 to 5, (poly-)p-phenylene vinylene derivative, polyphenylene derivative, polyvinyl carbazole, polythiophene derivative, perylene dye, coumarin dye, rhodamine dye can be used. Also an organic EL member can be doped to the above polymers to be used for an illuminating layer forming member. For example, rubrene, perylene, 9,10-diphenylanthracene, tetraphenylbutadiene, Nile red, coumarin 6, quinacridone can be doped to the above polymers.

A non-polar solvent should preferably not be soluble in the positive hole implantation/transportation layer 110a. For example, cyclohexylbenzene, dihydrobenzofuran, trimethylbenzene, tetramethylbenzene, can be used.

By using such non-polar solvent for the second composition in the illuminating layer 110b, it is possible to apply the second composition without re-melting the positive hole implantation/transportation layer 110a.

As shown in FIG. 20, the ejected second composition 110e spreads on the positive hole implantation/transportation layer 110a and is replenished in the lower opening section 112c and the upper opening section 112d. On the other hand, even if the first composition drop 110e is ejected on the water-repellant upper surface 112f off the predetermined ejection position, the upper surface 112f does not become wet by the second composition drop 110e; thus, the second composition drop 110e is transported in the lower opening section 112c and the upper opening section 112d.

The amount of the second composition which is ejected on the positive hole implantation/transportation layer 110a depends on factors such as the size of the lower opening section 112c, the size of the upper opening section 112d, the thickness of the illuminating layer 110b which is intended to be formed, and the density of the illuminating layer in the second composition, and the like.

Also, it is acceptable that the second composition 110e is ejected on the same positive hole implantation/transportation layer 110a not only once but also in plural times. In this case, the amount of the second composition in each time of the ejection can be the same. It is also acceptable that the liquid amount of the second composition change in each ejection. Furthermore, it is acceptable that the second composition be disposed and ejected not only in the same position on the positive hole implantation/transportation layer 110a but also in different positions in the positive hole implantation/transportation layer 110a in each time of the ejection operation.

Next, the second composition is ejected on the predetermined position, and after that, the ejected second composition drop 110e is processed to be dried. By doing this, the illuminating layer 110b3 is formed. That is, by performing the drying operation, the non-polar solvent which is included in the second composition evaporates and a blue (B) illuminating layer 110b3 is formed as shown in FIG. 21. Here, in FIG. 21, only one illuminating layer which illuminates in blue is shown. As shown in FIG. 9 or in other drawings, illuminating elements are formed in a matrix essentially; thus, it is should be understood that numerous illuminating layers which are not shown in the drawing (corresponding to blue) are formed.

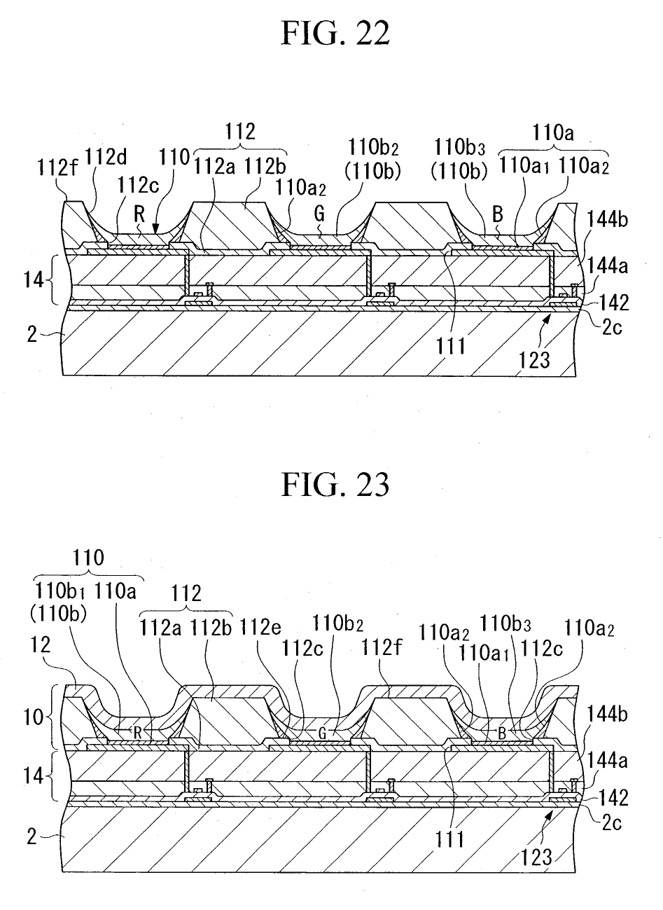

Consequently, as shown in FIG. 22, a red (R) illuminating layer 110b1 is formed in the same process as in the case of the above blue (B) illuminating layer 110b3. A green (G) illuminating layer 110b2 is formed last.

Here, the order for forming the illuminating layers is not limited to the above order. It is possible to form it in any forming order. For example, it is possible to determine the forming order according to the illuminating layer forming member.

For a drying condition for the second composition in the illuminating layer, for example, a condition such as 133.3 Pa (1 Torr) pressure with room temperature in a nitrogen atmosphere for 5 to 10 minutes can be proposed. If the pressure is too low, the second composition boils; thus, it is not preferable. Also, if the temperature is higher than room temperature, the evaporating speed in the non-polar solvent increases and numerous illuminating layers forming a member adhere to the wall surface in the upper opening section 112d; thus, it is not preferable.

Also, the green illuminating layer 110b2 and the red illuminating layer 110b2 have many ingredients for the illuminating layer forming member; thus, it is preferable to dry briefly. For example, it is preferable to perform nitrogen blowing operation for 5 to 10 minutes at 40° C.

For other drying conditions, it is possible to propose to use far infrared radiation methods, high temperature nitrogen gas blowing methods, and the like.

In this way, the positive hole implantation/transportation layer 110a and the illuminating layers 110b are formed on the pixel electrode 111.

(4) Facing Electrode (Cathode) Forming Process

Next, in the facing electrode forming process, as shown in FIG. 23, a cathode 12 (facing electrode) is formed on an entire surface of the illuminating layers 110b and the organic bank layer 112b.

It is acceptable that the cathode 12 is formed by layering a plurality of members. For example, it is preferable that a member having a small work function be formed near the illuminating layers. For example, it is possible to use Ca, Ba, and the like. Also, there is a case in which an LiF and the like is formed thereunderneath thinly. Also, it is possible for a member having a higher work function such as Al to be used thereabove (sealing area) than that thereunderneath.

It is acceptable that the lithium fluoride be formed only on the illuminating layers 110b. Furthermore, it is possible to form the lithium fluoride so as to correspond to the predetermined color. For example it is acceptable to form the lithium fluoride only on the blue (B) illuminating layer 110b3. In this case, an upper cathode layer 12 made from calcium contacts the red (R) illuminating layer 110b1 and the green (G) illuminating layer 110b2.

These cathodes 12 can be formed by a vacuum deposition method, a sputtering method, or a CVD method. In the present embodiment, the vacuum deposition method is used for the purpose of preventing a damage on the illuminating layer 110b due to the heat. That is, the base board 2 is disposed downwardly in the first vapor deposition processing chamber 84 and the second vapor deposition processing chamber 85 as shown in FIG. 16. By heating them member so as to evaporate therefor; thus, the cathode 12 is formed. In such a case, by using a different member in the first vapor deposition processing chamber 84 and the second vapor deposition processing chamber 85 and performing the vapor deposition operation while transmitting the base boards to both processing chambers, a stacked layer can be formed.

Also, it is preferable to use an Al layer or Ag layer of the like formed by vacuum evaporation method, sputtering method, CVD method and the like for an upper section of the cathode 12. Also, the thickness of the upper section of the cathode should preferably be in a range of nearly 100 to 1000 nm, in particular, nearly 200 to 500 nm.

Also, it is acceptable to dispose a protecting layer such as SiO₂, SiN, or the like on the cathode 12 for preventing oxidization.

(5) Sealing Process

Finally, in a sealing step, the base board 2 to which the illuminating element is formed and the sealing base board 3b are sealed via a member for sealing (sealing resin or the like) by using the sealing device 23 shown in FIG. 6.

In this embodiment, a sealing resin made of a thermosetting resin or an ultra-violet ray curable resin is applied on the marginal region section in the base board 2 by using the sealing resin applying processing chamber 86 shown in FIG. 6. By using the attaching processing device 87, the sealing base board 3b is disposed on the sealing resin.

By performing this step, the sealing section having a structure shown in FIG. 2 is formed.

The sealing process should preferably be performed in an inert gas atmosphere such as nitrogen gas, argon gas, and helium gas. If the sealing process is performed in an atmosphere, a water and an oxygen invade in the cathode 12 if a defect such as a pin hole is formed on the cathode 12; thus, there is a concern that the cathode 12 will be oxidized. Therefore, this is not preferable.

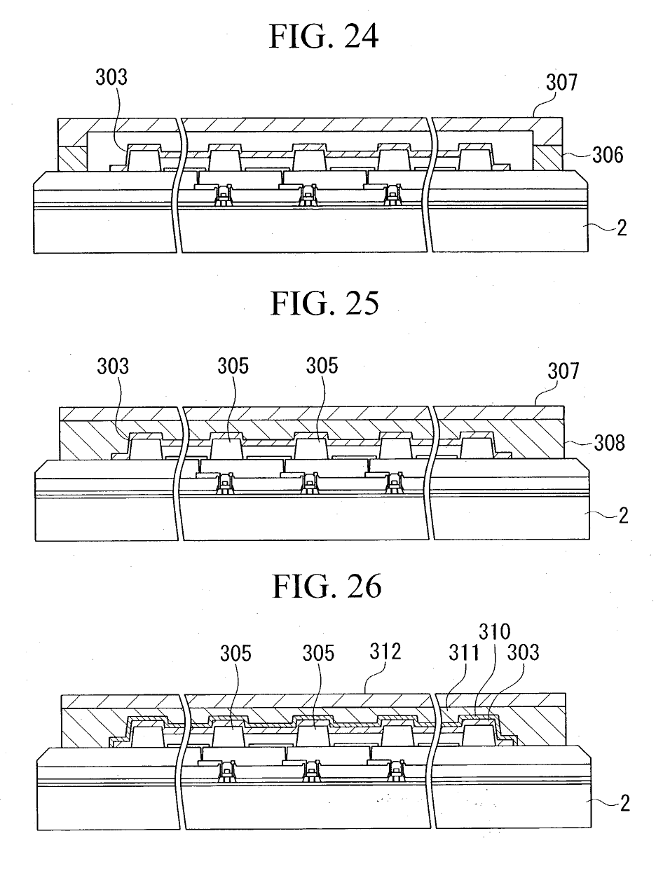

FIGS. 24, 25, and 26 show examples of structure in the sealing section.

In FIG. 24, a sealing resin 306 is disposed in the marginal region of the base board 2. A sealing base board (sealing can) 307 which is made of a glass member or a metal member is disposed so as to cover the cathode 303 by using a sealing resin 306 as a bonding agent.

In an embodiment shown in FIG. 25, the sealing member 308 is applied so as to cover approximately the entire cathode 12. The sealing base board (sealing can) 309 is disposed on the sealing member 308. For a sealing member 308, for example, a thermosetting resin or an ultra-violet ray curable resin which do not generate a gas or soluble when those resins are hardened are preferably used. Such a sealing member has a function for preventing a water or an oxygen from invading into the cathode 303 and avoiding oxidization of the cathode.

In an embodiment shown in FIG. 26, the first sealing member 310 is disposed so as to cover approximately the entire cathode 12. The second sealing member 311 is disposed on the first sealing member 310. The sealing base board 312 is disposed on the second sealing member 311. The first sealing member 310 has functions for enforcing the sealing function so as to prevent a water, an oxygen, or a metal member from invading. The sealing base board 312 has also a specific optical function for improving the extraction of light (improving the refractive index).

It is preferable that the sealing step is performed under condition of an inert gas atmosphere such as a nitrogen, an argon, or a helium, or the like. If the sealing step is performed under a normal atmosphere and there is a defect such as a pinhole on the cathode 12, it may occur that a water or an oxygen invade into the cathode 12 from such a defect; thus, it is not preferable because the cathode 12 is oxidized.

According to the above steps, the organic EL device is manufactured.

After that, the cathode 12 is connected to the wiring in the base board 2. Simultaneously, the wiring on the circuit element section 14 (see FIG. 9 for reference) is connected to the driving IC (driving circuit) which is disposed on the base board 2 or there outside. By doing this, an organic EL display device 1 according to the present invention is completed.

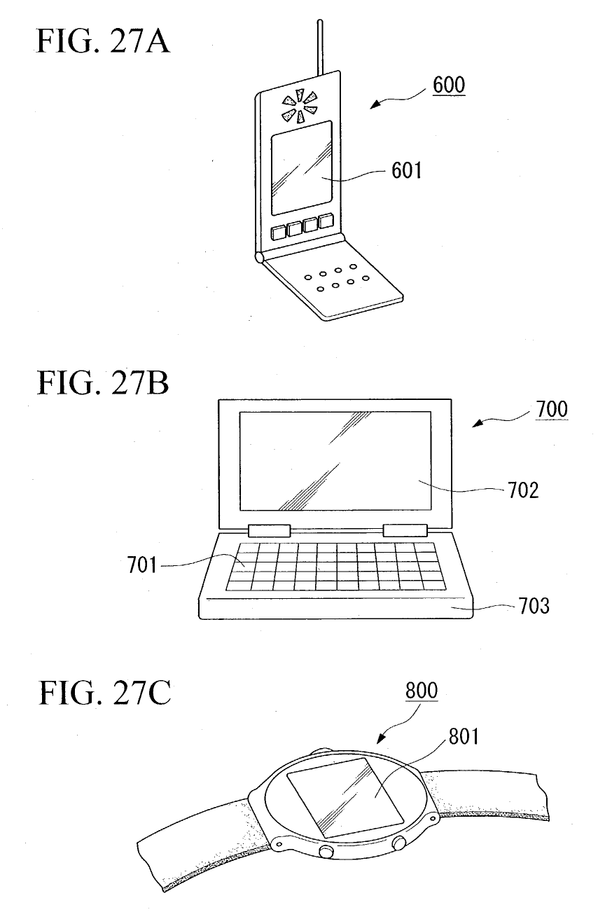

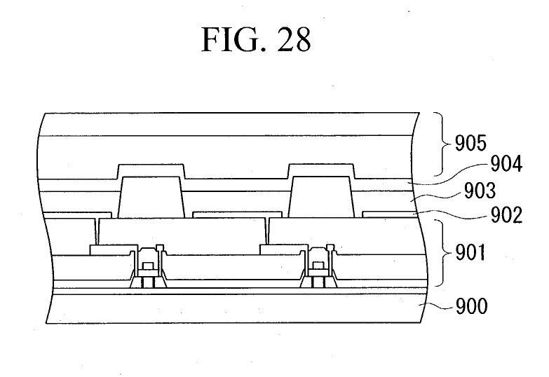

In FIGS. 27A to 27C, embodiments of an electronic apparatus according to the present invention are shown.

The electronic apparatus in the present embodiment is provided with an electrooptic device according to the present invention such as the above organic EL display device or the like as a display section.

FIG. 27A is a perspective view of an example of a mobile phone. In FIG. 27A, reference numeral 600 indicates a mobile phone unit. Reference numeral 601 indicates a display section which uses the above display device.

FIG. 27B is a perspective view of an example of a mobile information processing device such as a word processor or a personal computer. In FIG. 27B, reference numeral 700 indicates an information processing device. Reference numeral 701 indicates an input section such as a keyboard. Reference numeral 703 indicates an information processing device unit. Reference numeral 702 indicates a display section which uses the above display device.

FIG. 27C is a perspective view showing an embodiment of an electronic watch apparatus. In FIG. 27C, reference numeral 800 indicates a watch unit. Reference numeral 801 indicates a display section which uses the above display device. The electronic apparatuses shown in FIGS. 27A to 27C are provided with electrooptic devices for display sections according to the present invention. Therefore, it is possible to realize high quality in the display operation.

Preferable embodiments according to the present invention were explained above with reference to the attached drawings. It must be understood that the present invention is not limited to the above embodiments. Shapes and combinations shown in the above embodiments are only examples; thus, it is possible to make any modification to these embodiments within the scope of the present invention as defined by the claims.

What is claimed is:

1. Manufacturing method for an organic EL device comprising steps of:
forming a functional layer on an electrode which is formed on a base board;
forming a facing electrode which faces the electrode so as to sandwich the functional layer by performing vacuum deposition operation;
wherein base board converting step for converting the base board is arranged between the functional layer forming step and the facing electrode forming step.

2. Manufacturing method for the organic EL device according to claim 1 wherein a liquid drop which includes a member for forming the functional layer on the base board is ejected in the functional layer forming step.

3. Manufacturing method for the organic EL device according to claim 1 wherein the base board is transported from a device for forming the functional layer after the functional layer is formed and the base board is converted.

4. Manufacturing method for the organic EL device according to claim 1 wherein the base board is transported to a position where the facing electrode is formed by performing vacuum deposition operation and the base board is converted.

5. A manufacturing device for an organic EL device comprising:
a functional layer forming device for forming a functional layer on en electrode which is formed on a base board;
a base board converting device for converting the base board on which the functional layer is formed; and
a facing electrode forming device for forming a facing electrode which faces the electrode so as to sandwich the functional layer by performing vacuum deposition operation.

6. A manufacturing device for an organic EL device according to claim 5 wherein the functional layer forming device is provided with a liquid drop ejecting device for ejecting a member which forms the functional layer on the base board.

7. A manufacturing device for an organic EL device according to claim 5 wherein the functional layer forming device is a spin coating device.

8. A manufacturing device for an organic EL device according to claim 5 wherein the base board converting device transports the base board to and from a position where the facing electrode is formed by performing vacuum deposition operation.

9. A manufacturing device for an organic EL device according to claim 5 wherein the base board converting device is disposed between the functional layer forming device and the facing electrode forming device.

10. An electrooptic apparatus which is provided with an organic EL device which is manufactured by a manufacturing device for the organic EL device according to claim 9.

11. An electronic device which is provided with an electrooptic apparatus as a display device according to claim 10.

12. Manufacturing method for an organic EL device comprising steps of:
forming a cathode for the organic EL device which is formed on the base board by performing vacuum deposition operation; and
sealing the organic EL device, wherein
the base board is converted after the cathode forming step before the sealing step.

13. Manufacturing method for an organic EL device according to claim 12 wherein the sealing step includes a step for applying a sealing member on the cathode.

14. Manufacturing method for an organic EL device according to claims 1 or 13 wherein the base board is converted to a position where the cathode is formed by performing vacuum deposition operation according to the transportation of the base board.

15. A manufacturing device for an organic EL device comprising:
a cathode forming device for forming a cathode for the organic EL device which is formed on the base board by performing vacuum deposition operation;
a base board converting device form converting the base board; and
a sealing device for sealing the organic EL device.

16. A manufacturing device for an organic EL device according to claim 15 wherein the sealing device is provided with a sealing member applying section for applying the sealing member on the cathode.

17. A manufacturing device for an organic EL device according to claim 15 wherein the base board converting device transports the base board to a position where the cathode is formed by performing vacuum deposition operation.

18. An electrooptic apparatus which is provided with an organic EL device which is manufactured by a manufacturing device for an organic EL device according to claim 17.

19. An electronic apparatus which is provided with an electrooptic apparatus according to claim 18 as a display device.
